(19) United States
(12) Patent Application Publication
(10) Pub. No.: US 2023/0165758 A1
(43) Pub. Date: Jun. 1, 2023

(54) DELIVERY DEVICE FOR ORAL DOSAGE FORMS

(71) Applicant: OnDosis AB, Molndal (SE)

(72) Inventors: Kerstin Kha, Goteborg (SE); Asma Syed, Goteborg (SE); Magnus Karemyr, Goteborg (SE)

(21) Appl. No.: 17/916,656

(22) PCT Filed: Apr. 1, 2021
(86) PCT No.: PCT/EP2021/058765

§ 371 Date: Oct. 3, 2022

(30) Foreign Application Priority Data
Apr. 1, 2020 (GB) 2004831.0

(51) Int. Cl. A61J 7/00

(52) U.S. Cl. CPC A61J 7/0053

(57) ABSTRACT

The present application provides a device for dispensing an oral dosage form. The device includes a cartridge including one or more chambers for containing an oral dosage form, wherein each of the one or more chambers includes at least one outlet for dispensing the oral dosage form from the chamber. The device further includes a member that is movable between first and second positions, wherein in the first position the member is configured to receive and hold a specific volume of the oral dosage form from one of the chambers of the cartridge via one of the outlets, wherein the member is movable to one or more intermediate positions in which the specific volume of the oral dosage form is held and retained within the movable member such that the oral dosage form cannot be dispensed therefrom, and the member is movable from the intermediate position(s) to a second position in which the oral dosage form held within the movable member can be dispensed therefrom.

This application is entitled to the benefit of, and incorporates by reference essential subject matter disclosed in PCT Application No. PCT/EP2021/058765 filed on Apr. 1, 2021, which claims priority to GB Patent Appln. No. 2004831.0 filed Apr. 1, 2020, which are hereby incorporated by reference in their entireties.

### BACKGROUND OF THE INVENTION

### 1. Technical Field

The present disclosure (invention) relates generally to delivery devices for an oral dosage form, which could be solid, semisolid or liquid, for example pellets and/or powders and/or liquids (e.g., a drug or medicament in pellet/powder/liquid form) and various aspects of such devices relating, for example, to the dispensing of pellets/powder/liquid from the device, and the operation and mechanics of such devices. The invention is aimed at dispensing a reliable volume-based dose, for example a device capable of dispensing different volume-based dosages and/or different medicaments.

### 2. Background Information

Solid oral dosage form (“ODF”) medications can be manufactured in, e.g., a tablet or pellet form, or even as a powder. A tablet or pellet could contain different substances where the main ingredient(s) is/are the active pharmaceutical ingredient (“API”). Drug pellets could be administered to patients as prefilled capsules or compressed in a tablet with help filling materials. Dispensing mechanisms for various forms of ODF drugs are known, and can range from blister-pack type devices, wherein individual tablets can be retained within pockets and retained therein by the use of foil, to dispensing bottles. Various more complicated mechanisms are also known, in particular for other types of drug formulation, for example those in the form of pellets, which may typically be less than 10% of a particular dosage per unit. The advantage of dispensing drugs in pellet form can be that the dose can be varied using the same dispensing device. Another advantage is that the pellets could be easy to swallow by patients having difficulty swallowing, who are currently crushing the tablets in order to swallow. Crushing or dividing of tablets is also used today by patients to get, e.g., half a dose from a prescribed drug, a process which is not recommended and can be avoided if a device can dispense different flexible amounts of pellets. Variable dosing of pellets allows for a more exact tuning of the dose than what may be achieved using larger dosage forms such as tablets or capsules. Furthermore, for modified release formulations, pellets are often more robust against food interactions than larger dosage forms such as tablets.

Liquid dosage form medications are also known and typically correspond to the liquid form of a dose of a chemical compound used as a drug or medication intended for administration or consumption. Liquid dosage forms can be prepared, for example, by dissolving an active drug substance in an aqueous or non-aqueous solvent, such as by suspending the drug in an appropriate medium or by incorporating the drug substance into an oil or water phase.

Various methods have been used to dispense accurate doses of pellet-type medicaments, but the dispensing of a specific dosage of pellets has been found to be challenging.

### SUMMARY

Herewith will be described various aspects and embodiments of a dispensing device that may be used in the present invention, and in relation to any of the aspects and embodiments of the invention described herein insofar as they are suitable therefor.

In an aspect of the present invention, there is provided a device for dispensing at least one oral dosage form (e.g., a drug or medicament in solid, semisolid or liquid form).

The oral dosage form may be solid and may include one or more of tablets, pellets and a powder.

For example, the oral dosage form may be provided as solid units (e.g. pellets), wherein a largest dimension (e.g., width or diameter) of the units (e.g. pellets) may be as low as about 100 μm. The units may be between about 150 μm and about 1200 μm (or even about 1500 μm), optionally between about 200 μm and about 300 μm. Other size ranges are possible, such as between about 300 μm and about 500 μm, between about 500 μm and about 700 μm, between about 700 μm and about 900 μm or between about 800 μm and about 1100 μm.

A particularly preferred size range that suits the present invention has been found to be units (e.g. pellets) having a largest dimension (e.g., width or diameter) between about 100 μm and about 300 μm. Although larger sizes can still be used, using these smaller sizes can avoid clogging and other undesirable effects. In this size range (between about 100 μm and about 300 μm, such as between about 100 μm and about 250 μm and between about 100 μm and about 200 μm) good performance has been found for solid units of various materials.

The units (e.g., pellets) may be made of compressible and/or porous materials, which has been found to further avoid clogging/jamming, especially for the smaller sizes described above. In further refinements the units (e.g., pellets) may have a compressibility index (Carr's index) above 11% (e.g., between 11-15%), or the units may have a compressibility index (Carr's index) above 16% (e.g., between 16-20%). As is known in the art, Carr's index is equal to 100×(1−(bulk density of the material/tapped bulk density of the material)).

Generally, the units (e.g. pellets) may have an inconsistent or non-spherical shape and/or irregular size. The pellets could have a mixture of sizes within any of the ranges specified.

The oral dosage form could be provided in powder form. References to “powder” herein should be taken as the normal definition in the art, for example fine, dry particles that may be produced by some disintegration of a solid substance. In various embodiments, therefore, the solid oral dosage form may be in the form of a powder having a largest dimension (e.g., width or diameter) as low as about 40 μm and, optionally, up to about 250 μm or 300 μm. The powder could have a compressibility index (Carr's index) similar to that described above, namely above 11% (e.g., between 11-15%), or above 16% (e.g., between 16-20%).

The oral dosage form may be liquid or semisolid, such that volumes of medication of the form of liquids or semisolids (e.g., gels) could be delivered.

Moving now to the device, this comprises at least one cartridge, wherein each cartridge may comprise one or more chambers configured to store the oral dosage form, such as a plurality of units and/or a volume of a solid, semisolid or liquid oral dosage form. Each of the one or more chambers comprises at least one outlet for dispensing the oral dosage form from the chamber.

The device further comprises a member that is movable between first and second positions, wherein in the first position the member is configured to receive and hold a specific volume of the oral dosage form from one of the chambers of the cartridge via one of the outlets, wherein the member is movable to one or more intermediate positions in which the specific volume of the oral dosage form is held and retained within the movable member such that the oral dosage form cannot be dispensed therefrom (for example, in the intermediate position(s) the oral dosage form held within the movable member as a specific volume may be substantially fixed, i.e., the volume remains substantially the same), and the member is movable from the intermediate position(s) to a second position in which the oral dosage form held within the movable member can be dispensed therefrom.

This provides a device that is able to dispense a specific volume of an oral dosage form repeatedly, due to the use of an intermediate position in which the oral dosage form held within the movable member (as a specific volume) is substantially fixed. That is, in this intermediate position the oral dosage form cannot be added to or lost/dispensed, for example the oral dosage form cannot be dispensed into, through or out from the movable member.

The device is an improvement over conventional arrangements that involve dispensing a single unit of a medication (i.e., pills one-by-one). The device is configured and optimized for volume-based dosing, rather than unit-based dosing. For example, the size of the oral dosage form is generally much smaller than single pills, and may be provided in pellet or powder form, wherein the device is configured to hold multiple solid particles (e.g., 10s, 100s or even 1000s) in each chamber of the movable member (described below). Alternatively, as discussed above the oral dosage form may be semisolid or liquid. In addition to these general considerations, as discussed above it has been found that certain sizes of solid pellets, and also certain types of material provide optimized arrangements not envisaged by the conventional, single unit mechanisms.

The member may be slidable or rotatable between its first and second positions, which could cause a chamber within the movable member configured to hold the oral dosage form to slide or rotate as required, for example to move the chamber within the movable member into and out of alignment and/or communication with the chamber(s) of the cartridge and/or the outlet(s) thereof. This provides a simple and efficient mechanism by which to move the member between its first, intermediate and second positions.

The movable member may comprise at least one chamber, wherein each chamber of the member may be configured to receive and hold a separate (specific) volume of the oral dosage form from the cartridge. This means that different types of medication can be dispensed by the device using the same movable member. Where the oral dosage form is solid, the chamber may be configured to contain multiple units thereof (e.g., 10s, 100s or even 1000s), so as to provide a reliable volume-based dose of smaller unit types of medication. Where the oral dosage form is semisolid (e.g., a gel) or liquid, the chamber is configured in the intermediate position to hold and retain the oral dosage form within the chamber so that it cannot be dispensed therefrom.

Generally, in the intermediate position the chamber(s) may be completely isolated (e.g., sealed) from any chambers of the cartridge, such that no part of any chamber is aligned with or overlaps a chamber of the cartridge. This is distinct from conventional arrangements that transfer single units (e.g., pills one-by-one), but only use a slight misalignment and don't ensure that the chamber of the movable member is completely separated from those of the cartridge when transferring the oral dosage form from the cartridge to be dispensed. This is particularly important when the units are of a smaller size (e.g., in pellet or powder form), semisolid or liquid since the conventional arrangements that do not isolate in this manner would be entirely unsuitable.

The at least one chamber of the movable member may comprise a first chamber configured to receive and hold a first volume of the oral dosage form from the cartridge, and a second, separate chamber configured to receive and hold a second volume of the oral dosage form from the cartridge. This provides the movable member with the ability to hold various different volumes of the oral dosage form contained in the cartridge.

The first and second chambers of the member may receive and hold respective first and second volumes throughout movement of the member from the first to the intermediate position.

The first volume of oral dosage form may be different to the second volume of oral dosage form, for example a different type (e.g., size) of oral dosage form and/or different type of medication. The first volume of oral dosage form may (alternatively) be the same as the second volume of oral dosage form, for example to provide more flexibility in dispensing the same oral dosage form in differing volumes.

The cartridge may comprise multiple chambers, for example a first chamber and a second, separate chamber. Each of the first and second chambers of the cartridge may be configured such that the oral dosage form in one chamber does not intermix with the oral dosage form in the other chamber. Each chamber of the cartridge may comprise a separate outlet for dispensing the oral dosage form from the respective chamber. This can keep the oral dosage forms in the chambers separate from each other during use.

The first chamber of the movable member may be configured in the first position thereof to receive and hold the first volume of oral dosage form from one of the first and second chambers of the cartridge via its respective outlet, and the second chamber of the movable member may be configured in the first position thereof to receive and hold the second volume of oral dosage form from the other of the first and second chambers of the cartridge via its respective outlet.

In the first position of the member the first and second chambers thereof may both be configured to receive and hold a separate volume of oral dosage form from the cartridge at the same time, wherein in the second position of the member the first and second chambers thereof may both be configured to dispense their respective volumes of oral dosage form therefrom.

In the first position of the member the first chamber thereof may be configured to receive and hold a volume of oral dosage form from the cartridge, whilst the second chamber of the member is prevented from receiving the oral dosage form from the cartridge, and in the second position of the member the first chamber thereof may be configured to dispense its volume of oral dosage form and the second chamber of the member may be configured to receive and hold a volume of oral dosage form from the cartridge.

In the first position the second chamber may be configured to dispense its volume of oral dosage form.

The movable member may comprise a first portion having the first chamber thereof and a second, separate portion having the second chamber thereof, wherein the first and second portions are movable relative to each other. The first and second portions could be separate pieces that are connected together in such a manner as to allow one to move relative to the other.

The first and second portions may be movable relative to each other such that in a first relative position of the first and second portions the first and second chambers of the member align such that the oral dosage form can pass therebetween, and in a second relative position of the first and second portions the first and second chambers of the member move out of alignment such that the oral dosage form cannot pass therebetween.

In the first position of the movable member the first and second portions thereof may be movable into alignment to their first relative position, such that they are both configured to receive and hold a volume of oral dosage form from the cartridge at the same time, wherein the first and second portions of the member may be configured to remain aligned in their first relative position throughout movement of the member to its second position, such that a volume of oral dosage form corresponding to the combined volume of the first and second chambers of the member can be dispensed therefrom.

In the first position of the movable member the first and second portions thereof may be movable out of alignment to their second relative position, such that only one of the first and second chambers is configured to receive and hold a volume of oral dosage form from the cartridge, wherein the first and second portions of the member may be configured to move from their second relative position to their first relative position throughout movement of the member to its second position, so as to become aligned such that a volume of oral dosage form corresponding to the one of the first and second chambers of the member can be dispensed therefrom.

The first portion may comprises a first disc having the first chamber of the member, and the second portion may comprise a second disc having the second chamber of the member, wherein the first and second discs are rotatable relative to each other and the cartridge.

The first disc may be rotatable between a first position in which the first chamber thereof is configured to receive and hold a specific volume of oral dosage form from the cartridge. The first disc may then be rotatable to one or more intermediate positions in which the oral dosage form held within the first chamber thereof as a specific volume is substantially fixed. The first disc may then be rotatable from the intermediate position(s) to a second position in which the oral dosage form held within the first chamber thereof can be dispensed therefrom.

The second disc may be rotatable between a first position in which the second chamber thereof is configured to receive and hold a specific volume of oral dosage form from the cartridge. The second disc may then be rotatable to one or more intermediate positions in which the oral dosage form held within the second chamber thereof as a specific volume is substantially fixed. The second disc may then be rotatable from the intermediate position(s) to a second position in which the oral dosage form held within the second chamber thereof can be dispensed therefrom.

The member may be configured such that upon rotation of the first disc in a first direction the second disc is also configured to rotate, whilst upon rotation of the first disc in a second, opposite direction the second disc is configured to remain stationary. This may be such that rotating the first disc in the first direction allows only the oral dosage form held within the first chamber thereof can be dispensed therefrom, and rotating the first disc in the second direction allows the oral dosage form held within both the first chamber and the second chamber to be dispensed therefrom.

A one-way bearing may be located between the first and second discs. Alternatively a ratchet mechanism may be located between the first and second discs.

The device may comprise one or more outlet passages configured to receive the oral dosage form dispensed from the movable member in the second position thereof.

The device may comprise one or more rotating members extending through the cartridge. The rotating member(s) may be configured to operate a plunger, as described below, and/or configured to actuate a respective screw pump, so as to aid in dispensing the oral dosage form from each of the one or more chambers of the cartridge to the movable member. The device may comprise an actuator configured to rotate the rotating member(s) as described below.

The use of a screw pump is an optional feature, and not essential for the present invention. Although it may have a particular utility for the technology described herein, any suitable method of dispensing the oral dosage form may be used and the invention should not be seen as limited to embodiments involving the use of a screw pump.

The cartridge may extend from a first end to a second, dispensing end, and each screw pump may be located at the second, dispensing end of the cartridge.

The device may be a hand-held device.

The device may further comprise a plurality of pellets providing the oral dosage form contained within each of the one or more chambers.

Each chamber may comprise a dispensing mechanism, for example a screw pump, e.g., an Archimedes screw, wherein each dispensing mechanism is configured to receive a plurality of units of the oral dosage form from the respective chamber and (e.g., upon rotation of the screw pump) transport the units of the oral dosage form from the respective chamber to be dispensed from the device (and, e.g., the cartridge and/or chamber) as described herein.

A rotating member as described above may extend through each chamber, and may be configured to actuate the dispending mechanism (e.g., rotate the screw pump) so as to dispense a plurality of units of the oral dosage form therefrom.

The cartridge may comprise one or more exit tubes extending from each chamber. Each exit tube may contain a respective dispensing mechanism (e.g., screw pump).

In an aspect of the invention there is provided a method of using a device having a dispensing mechanism (e.g., screw pump described above, or plunger described below), the method comprising actuating one or more of the dispensing mechanisms (e.g., rotating the rotating member) to cause the dosage form to be dispensed from the respective chamber(s).

The method may further comprise: filling the chamber(s) with an oral dosage form; determining an amount of actuation (e.g., rotation of the rotating member) that will cause a predetermined amount of the oral dosage form to be dispensed from the device; and actuating the dispensing mechanisms (e.g., rotating the rotating member) by the predetermined amount to cause the predetermined amount of oral dosage form to be dispensed from the device.

The chamber(s) may extend from a first end of the device to a second, dispensing end of the device. The cartridge(s) may extend from the first end to the second, dispensing end, and the actuating mechanisms (e.g., screw pump) may be at least partially located at the second, dispensing end of the chamber(s).

The actuating mechanism(s) may be gravity fed. In other words, the oral dosage form held within the chamber(s) may be moved towards the second, dispensing end at least partially by gravity, when the device is in a dispensing orientation (for example, with the dispensing end pointing downwards).

The device may be a hand-held and/or portable device. In other words, the device may be held and transported using one hand and/or operable using one hand.

For example, the device may have a length (corresponding to its longest dimension) of no more than about 250 mm (such as less than about 200 mm, about 150 mm or about 100 mm), and a width or height (i.e., transverse to its length) of no more than about 50 mm, and optionally no more than about 40 mm (and in some embodiments less than 30 mm or even less than 20 mm).

In order to optimize its hand-held nature, the device may have a length between about 150 mm and about 220 mm (for example about 160 mm and about 180 mm, and optionally about 165 mm), a width (transverse to its length) between about 35 mm and about 45 mm (optionally about 40 mm), and a height (transverse to its width) of between about 22 mm and about 32 mm (optionally about 28 mm).

The device may weigh no more than about 500 g, about 400 g, about 300 g, about 200 g, or even about 100 g. This can ensure that the device is light enough to carry in one hand.

In embodiments involving a screw pump and rotating member as part of the actuating mechanism(s), each screw pump may be or comprise part of a respective rotating member. For example, the screw pump may comprise one or more screw threads formed around the rotating member. The term “one or more” is used herein due to the possibility that the screw pump may comprise one or more screw starts, each forming a separate screw thread. Although the plural term is used hereinafter for brevity, it will be appreciated that the references to screw threads encompass a singular screw thread.

The device may be configured such that as the rotating member and screw pump are rotated in use, the oral dosage form travels along the screw threads of the screw pump from the portion of the screw threads extending into each respective chamber to the opposite end of the screw threads for dispensing from the screw pump.

The screw threads may cooperate with an inner cylindrical surface of each respective cartridge to form the screw pump(s), such that, as the rotating member rotates in use, the screw threads rotate within the inner cylindrical surface, causing the oral dosage form contained within the chamber(s) to enter the screw threads, and travel down the screw threads for dispensing from the screw pump(s). It should be noted that the cartridge may not itself be generally cylindrical. Rather, in order to form the screw pump the cartridge may comprise an inner cylindrical surface, although this should not be interpreted as necessarily meaning the cartridge itself is cylindrical in whole or in part.

In any of the aspects and embodiments described herein, gravity (and/or a plunger device as described below) may be used to move the oral dosage form to the dispensing end of the chamber(s), at which point the oral dosage form may be output therefrom (e.g., via an outlet) and/or collected by a respective dispensing mechanism(s) (e.g., screw pump(s)).

The device may further comprise one or more devices (e.g., a plunger) configured to force the oral dosage form contained within each chamber towards a respective outlet and/or dispensing mechanism (e.g., screw pump). This device may act in addition to gravity, such that a combination of gravity and the force provided by the device moves the oral dosage form contained within the chamber towards the outlet. For example, the device may be or comprise a plunger (e.g., in the form of a weight) that is configured to rest on top of the oral dosage form contained within the chamber when the device is in an orientation that permits dispensing of the oral dosage form.

A dispensing mechanism could be provided by the combination of a plunger and rotating member as described above, wherein the dispensing mechanism comprises a plunger configured to move along the or each rotating member automatically and/or as a result of the rotation of the rotating member(s). For example, a portion of the rotating member within each respective chamber may comprise a screw thread (e.g., a plunger screw thread), and the plunger may form a nut around the rotating member that is configured to travel along the screw thread of the rotating member in use, such that, as the rotating member rotates, the plunger moves towards the outlet and/or dispensing mechanisms (e.g., screw pump) so as to force (push) the oral dosage form contained within the chamber towards the outlet/dispensing end thereof.

Especially (although not exclusively) in the case of a semisolid or liquid dosage form, the plunger may be sealed (e.g., fluidly) against the walls of the chamber and/or a or the screw thread along which it travels, so as to help prevent undesired leakage from the various chambers and passages of the device. Suitable fluid seals may be used between the various components of the device, especially any components that move relative to one another, to help prevent undesired leakage.

The device may further comprise a valve configured to prevent the oral dosage form from being dispensed from the outlet of the chamber(s) unintentionally, for example outside of a dispensing operation (e.g., a screw pump is not being rotated) or prior to use. The valve may be configured to permit the oral dosage form to be dispensed only during a dispensing operation, e.g., upon rotation of the rotating member.

The valve may comprise a resilient portion, e.g., a rubber membrane, that is configured to flex open to allow the oral dosage form to be dispensed (e.g., as the rotating member rotates in use), and then flex back (e.g., when the rotating member is not rotating), so as to stop or prevent the oral dosage form falling out of the chamber(s) and to help seal the chamber(s) and/or cartridge.

The device may comprise one or more actuators configured to operate each dispensing mechanism (e.g., rotate each rotating member). The actuator may be a mechanical or electromechanical actuator. The actuator may be located at the first end of the device.

The actuator may be configured to rotate each rotating member (in relevant embodiments). This may cause (also in relevant embodiments) a plunger to move down the screw portion of the rotating member, and/or the screw section to rotate, causing the oral dosage form to be dispensed.

The actuator may be an electromechanical actuator (e.g., comprising one or more motors) or comprise an electromechanical actuating mechanism, so that the device may be able to dispense a precise dose or amount (e.g., a precise volume) of the oral dosage form repeatedly. The motors, and the control system may be powered by an integrated battery (which may be user replaceable), which may be held within the housing of the actuator.

The device may include a control system (e.g., as part of the actuator), which may be configured to dispense the dose or amount (e.g., the precise volume) within a predetermined time (e.g., less than 2, 3 or 5 seconds) after receiving an actuating signal from an input device or mechanism. The actuating signal may be initiated, for example, by a user pressing a suitable button or other input mechanism located on the device or optionally via a different control such as a wireless or wired, external control.

The actuator may comprise one or more electric (e.g., stepper) motors, which could be configured to operate the dispensing mechanism(s) by any suitable number of turns (e.g., steps) based on the situation at hand, e.g., based on the type of oral dosage form/medicament within the chamber(s), or the user. The control system may be provided in the form of a microcontroller, e.g., on a printed circuit board (“PCB”), which may be located within the housing of the device of within the actuator.

In aspects of the present invention, there is provided a method of using a device in any of the aspects and embodiments described above.

The method may comprise operating at least one of the dispensing mechanisms, for example by rotating a rotating member by a predetermined amount of rotation, to cause a predetermined amount of the oral dosage form to be dispensed from the device.

The method may further comprise filling each chamber with an oral dosage form, determining an amount of rotation of the screw pump that will cause a predetermined amount of the oral dosage form to be dispensed from the device, and operating at least one of the dispensing mechanisms, for example by rotating a rotating member by a predetermined amount of rotation, to cause the predetermined amount of the oral dosage form to be dispensed from the device. As noted above the oral dosage form could be solid, semisolid or liquid.

The method may comprise storing an oral dosage form within the cartridge (e.g., the chambers thereof). The oral dosage form may include a medication or compound for treatment of one or more of Attention Deficit Hyperactivity Disorder (“ADHD”—wherein the medication or compound could include amphetamines and/or methylphenidate), general pain (wherein the medication or compound could include one or more of fentanyl, methadone, meperidine, tramadol, morphine, codeine, thebaine, oxymorphone, hydrocodone, oxycodone, hydromorphone, naltrexone, buprenorphine and methadone), immunosuppression post organ transplant (wherein the medication or compound could include one or more of tacrolimus, sirolimus, everolimus, corticosteroids, cyclosporine, mycophenolate and azathioprine), diabetes (wherein the medication or compound could include one or more of sitagliptin, vildagliptin, saxagliptin, linagliptin, metformin, canagliflozin, Dapagliflozin, empagliflozin and semaglutide), heart failure (wherein the medication or compound could include one or more of carvedilol, metoprolol, bisoprolol and diurethics), Parkinson's disease (“PD”—wherein the medication or compound could include levodopa and/or carbidopa), epilepsy (wherein the medication or compound could include one or more of sodium valproate. carbamazepine, lamotrigine, levetiracetam, oxcarbazepine, ethosuximide and topiramate), depression (wherein the medication or compound could include one or more of Citalopram, bupropion, paroxetine, milnacipran, fluoxetine, duloxetine, fluvoxamine and reboxetine), schizophrenia (wherein the medication or compound could include one or more of aripiprazole, asenapine, brexpiprazole, cariprazine, clozapine, iloperidone, lurasidone and olanzapine), cancer, animal health.

The oral dosage form may include a medication or compound for treatment of one or more of: Riociguat or Selexipag for Pulminary Arterial Hypertension; Perampanel or Cenobamate for Epilepsy; Siponimode for Multiple Sclerosis; Vortioxetine, Aripiprazol, Brexpiprazol or Cariprazine for Depression/Schizophrenia; Lenalidomide for Myeloma; Memantine for Alzheimers; Deflazacort or Ataluren for Duchenne Muscular dystrophy; Deutetrabenazine for Tardive Dyskinesia; Osilodrostat for Cushing's disease; Sisunatovir for Respiratory syncytial virus; Peanut allergen powder for Peanut allergy; Fenfluramine for Dravets syndrome.

The method may include using the device in the treatment of one or more of Attention Deficit Hyperactivity Disorder (“ADHD”), general pain, immunosuppression post organ transplant, diabetes, heart failure, Parkinson's disease (“PD”), epilepsy, depression, schizophrenia, cancer, and animal health. The oral dosage form within the cartridge (e.g., the chamber thereof), when used in a particular treatment, may include one or more of the medications or compounds referred to above in respect of that particular treatment.

### Definitions

Pellet—A single granule/unit of a solid oral dosage form (e.g., a medicament, drug, medication, etc.) having a largest dimension (e.g., width or diameter) as low as about 100 μm. The units may be between about 150 μm and about 1200 μm (or even about 1500 μm), optionally between about 200 μm and about 300 μm. Other size ranges are possible, such as between about 300 μm and about 500 μm, between about 500 μm and about 700 μm, between about 700 μm and about 900 μm or between about 800 μm and about 1100 μm.

A particularly preferred size range that suits the present invention has been found to be units (e.g. pellets) having a largest dimension (e.g., width or diameter) between about 100 μm and about 300 μm. Although larger sizes can still be used, using these smaller sizes can avoid clogging and other undesirable effects. In this size range (between about 100 μm and about 300 μm, such as between about 100 μm and about 250 μm and between about 100 μm and about 200 μm) good performance has been found for solid units of various material.

Powder—fine, dry particles that are produced by disintegration (e.g., crushing, grinding) a solid substance, and each particle having a largest dimension (e.g., width/diameter) as low as about 40 μm and, optionally, up to about 250 μm or 300 μm.

Dose—A single measurement (e.g., volume or weight) of an oral dosage form (e.g., solid, semisolid or liquid), for example totaling between about 0.05 ml to about 0.8 ml (such as about 0.1 ml to about 0.6 ml) by volume, for example about 0.3 ml by volume (although it should be noted that sometimes oral dosage forms are measured by weight).

Dispensing Mechanism—A system, e.g., an electromechanical system that converts a user's action into the dispensing of a dose.

Cartridge—A component, e.g., a replaceable component used to store and dispense an oral dosage form, optionally containing features of the device such as a rotating member in the form of, e.g., a central threaded bar, a moving plunger and the oral dosage form.

Plunger—A plate (although other types of plunger are envisaged) that can ensure the oral dosage form moves (and in the case of a solid oral dosage form stays packed together) toward the dispensing end of the cartridge. The plate may be substantially rigid, but portions of the plate may be flexible, for example those portions that interact with other parts of the cartridge.

Dispensing Aperture—The open end of the cartridge or chamber(s) that allows the oral dosage form to be dispensed for consumption.

Cap—A container or tray that covers the delivery aperture, for collection of a dose and for protection of the stored oral dosage form from humidity.

Press—An action performed by a user on the device when they wish to dispense their specified dosage, this could be rotary or linear motion.

It will be appreciated that references to “a” drug or medicament as referred to herein may be taken as “one or more” drugs or medicaments. For example, the oral dosage form could comprise several drugs or medicaments. This could be achieved by mixing solid oral dosage forms, each comprising a different drug or medicament (e.g., each unit of oral dosage form may comprise a different drug or medicament to other units), and/or mixing drugs or medicaments within each solid oral dosage form (e.g., each unit may itself contain different types of drug or medicament).

### BRIEF DESCRIPTION OF THE DRAWINGS

Various embodiments will now be described, by way of example only, and with reference to the accompanying drawings in which:

FIG. 1 shows a cross-sectional view of part of a device 100, which is a delivery device capable of dispensing a drug or medicament;

FIG. 2 shows an embodiment of a device, which may incorporate features of the device shown in respect of FIG. 1;

FIGS. 3A-C show embodiments of a device comprising a cartridge having a single chamber configured to store an oral dosage form;

FIGS. 4A-C show an embodiment similar to that of FIGS. 3A-C, but wherein a movable member slides between its first and second positions in a manner similar to that described in respect of FIG. 2;

FIGS. 5A-C, 5D-F and 5G-I illustrate an embodiment comprising a movable member that is split into separate pieces that are movable relative to each other;

FIGS. 6A-C, 6D-F and 6G-I illustrate an embodiment similar to that of FIGS. 5A-C, 5D-F and 5G-I respectively, but comprising a movable member in which first and second portions are slidable relative to each other, rather than rotatable;

FIG. 7 shows an embodiment of a device in which a movable member is split into multiple component parts;

FIGS. 8A-F illustrate (schematically) the embodiment of FIG. 7 and the sequence of rotations that may be used to dispense an oral dosage form from the device;

FIG. 9 schematically shows a similar but alternative embodiment to that of FIG. 7, in which one or more ratchet mechanisms are used in place of a one-way bearing; and

FIG. 10 shows an embodiment of a device capable of dispensing a drug or medicament.

### DETAILED DESCRIPTION

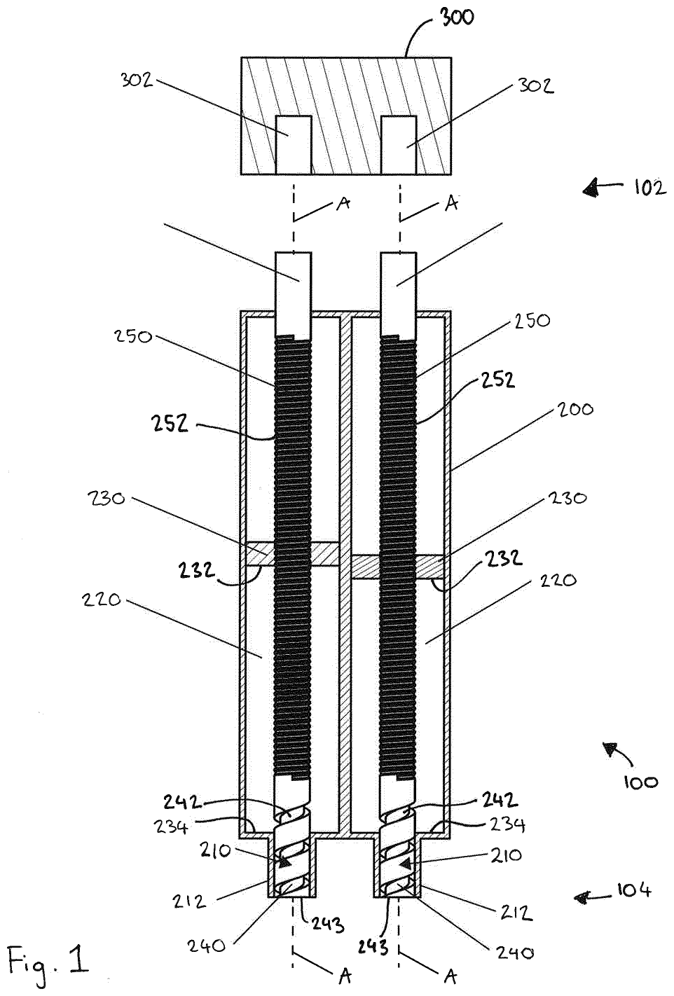

FIG. 1 shows a cross-sectional view of part of a device 100, which is a delivery device capable of dispensing a drug or medicament (e.g., an oral dosage form). This is but one example of a device that may be suitable for use with the invention as defined in its broadest terms by the claims. Various examples of such devices are described, for example, in PCT application numbers PCT/EP2018/085320 and PCT/EP2019/079999, the contents of which are incorporated by reference in their entirety. For brevity, the different types of device are not described in detail herein, and it will be appreciated that any suitable device for dispensing an oral dosage form (e.g., solid or liquid) may be used, and the invention should not be seen as limited to use with any specific type of device, or mechanism for dispensing the oral dosage form.

It will further be appreciated, and as discussed in more detail below, that the present invention relates in various embodiments to a device for dispensing a volume-based dosage of a drug or medicament (e.g., oral dosage form). As such the embodiments discussed below lend themselves well to the use of the device in connection with solid oral dosage forms such as tablets and pellets, but also smaller types such as a powder, and even semisolid or liquid dosage forms.

For brevity the various embodiments and figures may show or describe a solid oral dosage form (e.g., pellets), but this should not be seen as limiting the present disclosure to the use of such a dosage form. In other words, and generally the present invention, and various embodiments thereof, should not be seen as being limited to a particular type of dosage form.

The device 100 comprises a first end 102 for connecting to an actuator 300 or other driving mechanism (e.g., a motor), and a second end 104 (opposite the first end 102) that comprises the dispensing end of the device 100. In use, the medication (e.g., oral dosage form) will be dispensed out of the second end 104 as a result of the operation of the driving mechanism (e.g., motor).

The device 100 comprises a cartridge 200 that is configured to attach to the actuator 300 or driving mechanism (e.g., motor) at the first end 102 of the device 100.

The device 100 comprises one or more rotating members 250 extending through the cartridge 200. As described in more detail below, at the first end 102 of the device 100 the rotating members 250 connect to the actuator 300, which is configured to rotate the rotating members 250 (e.g., separately and/or independently) so as to cause the oral dosage form to be dispensed from the second end 104 of the device 100.

The device 100 comprises one or more exit tubes 212 at the second end 104 thereof, through which the oral dosage form (drug, medicament, etc.) may be dispensed.

FIG. 1 shows the interior of the cartridge 200 and some features of the rotating members 250 in more detail. The cartridge 200 is hollow and comprises one or more chambers 220 for holding a plurality of units of an oral dosage form (e.g., pellets), and through which the rotating members 250 extend from the first end 102 of the device 100 to the second end 104 of the device 100.

The chambers 220 and/or the cartridge 200 may be substantially fluidly and/or hermetically sealed (e.g., with the exception of the passage through which pellets are dispensed). For example, at the first end 102 the connection between the rotating member 250 and the cartridge 200 may comprise a seal, for example an elastomeric gasket or valve (not shown). Similarly, at the second, dispensing end 104 of the device 100 a suitable seal (not shown) may be provided between the rotating member 250 and exit tubes 212.

Additionally, or alternatively a valve (not shown) may be used to at least partly seal the second, dispensing end of the device 100. The valve may be connected to each exit tube 212 and configured to prevent the oral dosage form from being dispensed from the exit tube unintentionally, for example outside of a dispensing operation when the dispensing mechanism is not being operated (e.g., a rotating member 250 is not being rotated) or prior to use. The valve may be configured to permit the oral dosage form to be dispensed from the dispensing mechanism only during a dispensing operation, e.g., upon rotation of the rotating members 250. The valve may comprise a resilient and/or deformable material, e.g., a rubber membrane, that is configured to flex open to allow the oral dosage form to be dispensed from the exit tube 212 (e.g., as the rotating member 250 rotates in use), and then flex back (e.g., when the rotating member 250 is not rotating), so as to stop the oral dosage form falling/dripping out of the exit tube 212 and to help seal the chambers 220.

Upon rotation of one or more of the rotating members 250 the oral dosage form may be urged towards the end of the exit tube(s) 212 for dispensing from the device 100, and upon meeting the resilient material, the oral dosage form will be forced against the resilient material, which can cause it to deform, creating a gap through which the oral dosage form can be dispensed. At the end of the dispensing operation, once the rotating member 250 has stopped rotating, the oral dosage form will no longer be urged against the deformable material and the deformable material can spring back into its resting, sealing position.

The valve can help prevent air and/or moisture from entering the chambers 220 and interacting with the units of the oral dosage form undesirably.

Each rotating member 250 may extend into a respective exit tube 212 at the second end 104 of the device 100, and may comprise a screw section 240. Together, the exit tube 212 and screw section 240 may combine to form a screw pump 210 configured to dispense the oral dosage form from the second end 104 of the device 100. That is, the oral dosage form will enter a screw thread 242 of the screw section 240 and, upon rotation of the rotating member 250, will be forced out of the exit tube 212 via the screw thread 242 and be dispensed from the device 100. The use of a screw pump 210 is not essential, and the chamber may simply comprise an outlet at the dispensing end through which units (pellets) are dispensed (e.g., only by gravity). For example, the exit tube 212 may be hollow, or not used (in which case a simple aperture could be present in the end surface 234 of the chamber 220).

Each rotating member 250 may have a longitudinal axis A about which it rotates, which may also be the axis of rotation of the screw pump 210.

The device 100 may further comprise one or more plungers 230 that are configured to move along a respective rotating member 250 automatically or as a result of the rotation of the rotating member 250.

Each cartridge 200 holds the oral dosage form within one or more chambers 220 thereof, as described above. In embodiments involving one or more plungers 230, the volume of each chamber 220 varies during operation of the device 100 and throughout its lifetime by the action of the plunger 230, which will be described in more detail below.

At one end, each chamber 220 is enclosed at least in part by its respective plunger 230, and more specifically a radially extending surface 232 of the plunger 230 that faces the chamber 220. The other end of the chamber 220 is enclosed at least in part by a respective surface 234 of the cartridge 200. Each rotating member 250 extends through its respective chamber 220 along its longitudinal axis A.

As the rotating member 250 is rotated in use, the plunger 230 rests on top of the oral dosage form (not shown) located within the chamber 220.

The plunger(s) 230 may act by gravity, to move the oral dosage form contained within the chamber 220 towards the screw pump 210 (or outlet if a screw pump 210 is not used). For example, the plunger 230 may be a weight configured to rest on top of the oral dosage form contained within the chamber when the device 100 is in an orientation that permits dispensing of the oral dosage form.

Each plunger 230 may be configured to move along its respective rotating member 250 automatically or as a result of the rotation of the rotating member 250. For example, a portion of the rotating member 250 within the chamber 220 may comprise a screw thread 252 (e.g., a plunger screw thread, which may be distinct from any screw thread 242 of the screw pump 210, if provided), and the plunger 230 may form a nut around the rotating member 250 that is configured to travel along the screw thread 252 of the rotating member 250, such that, as the rotating member 250 rotates, the plunger 230 moves towards the screw pump so as to force pellets contained within the chamber 220 towards the screw pump 210 (or outlet if a screw pump 210 is not used).

Especially (although not exclusively) in the case of a liquid dosage form, the plunger 230 may be sealed (e.g., fluidly) against the walls of the chamber 220 and/or a or the screw thread 250 along which it travels, so as to prevent undesired leakage. For example, a suitable elastomeric seal could be provided that is configured to fluidly seal against the walls of the chamber 220 and/or screw thread 250.

As the plunger 230 translates along the rotating member 250 the volume of the chamber 220 gradually decreases. Furthermore, the oral dosage form contained within the chambers 220 will be forced (pushed) towards the second end 104 of the cartridge 200 by the plungers 230 throughout the operation and lifetime of the device 100. In use the radially extending surface 232 of the plunger 230 presses onto the oral dosage form and forces this towards the second, dispensing end 104 of the device 100, which, in the case of a solid oral dosage form, and especially pellets, can assist in packing them tightly within the chamber 220.

It should be noted, however, that use of a plunger 230, while useful, is not seen as essential for the broadest aspects of the invention described herein.

At the second, dispensing end 104 of the cartridge 200 the rotating member 250 comprises the screw section 240, which is axially separated from the screw thread 252 that cooperates with the plunger 230.

FIG. 1 shows the second, dispensing end 104 of the cartridge 200, at which end there is located the optional exit tubes 212, with the optional screw section 240 of each rotating member 250 extending through the exit tube 212 as discussed above.

Each screw section 240 comprises a screw thread 242 configured to receive the oral dosage form contained within the respective chamber 220 and transport this, upon rotation of the rotating member 250, along the screw thread 242 to be dispensed out of the exit tube 212. The screw thread 242 consists of one or more starts, each forming a continuous helix that the oral dosage form fills during operation of the device 100, for example due (at least in part) to the action of the plunger 230, if provided, pressing on the oral dosage form within the chamber 220, which can force this into the screw thread 242.

The screw section 240 and the screw thread 242 thereof contact the inner radial surface of the exit tube 212 so as to form a screw pump 210 (e.g., an “Archimedes” screw) with the exit tube 212 of the cartridge 200. That is, as the rotating member 250 rotates, the screw section 240 and screw thread 242 thereof will also rotate, causing the oral dosage form contained within the chamber 220 to enter the voids of the screw thread 242, travel down the screw thread 242 and exit the cartridge 200. The screw pump 210 may comprise an outlet 243 through which the oral dosage form is dispensed.

The actuator 300 or driving mechanism (e.g., one or more motors 302) may be configured to rotate each respective rotating member 250 (e.g., separately and/or independently), and may be connected to the rotating member 250 at the first end 102 of the device 100 as described above.

The actuator 300 may be configured to provide a rotary force to the rotating members 250, and, in turn, to the screw thread(s) 242, 252 of the rotating member 250. The actuator 300 can be either mechanical (e.g., manually operated) or electromechanical (e.g., electrically operated, for example an electric motor). The actuator 300 (or a control unit comprising the actuator) could be detachable from the cartridge 200, so that different cartridges 200 could be connected to the same actuator 300 or control unit.

In order to dispense the oral dosage form from the cartridge 200, the actuator 300 may rotate one or more of the rotating members 250. This causes the rotating member(s) 250 to rotate, causing the oral dosage form to be dispensed (e.g., via the screw pump(s) 210).

The device 100 may include a control system (e.g., as part of the actuator 300 or a control unit), which may be configured to dispense a dose of the oral dosage form contained within the chambers 220, for example after receiving an actuating signal from an input device or mechanism. The actuating signal may be initiated, for example, by a user pressing a suitable button or other input mechanism located on the control unit or optionally via a different control such as a wireless or wired, external control.

By using an electromechanical actuating mechanism, the device 100 may be able to dispense a precise dose or amount (e.g., volume) of the oral dosage form repeatedly. The motors 302, and the control system may be powered by an integrated battery (which may be user replaceable), which may be held within the housing of the actuator 300.

The actuator 300 may comprise one or more motors 302. The actuator 300 (e.g., the motors 302 thereof) may be configured to rotate each rotating member 250 by an amount corresponding to a prescribed dose, or a portion of a dose (which may correspond to a specific volume of the oral dosage form).

The motors 302 may be stepper motors, which could be configured to rotate a respective rotating member 250 by any suitable number of steps based on the situation at hand, e.g., based on the type of medicament within the cartridge 200, or the user. The control system may be provided in the form of a computer, processor, processing device, circuitry or microcontroller, e.g., on a PCB, which may be located within the housing of the device 100 of within the actuator 300 or control unit.

The volume of each chamber 220 (i.e., prior to operation or a maximum volume) may be less than about 50 mL, for example less than 20 mL or approximately 11 mL.

In various embodiments, the screw thread 242 (where provided) may extend into the chamber 220 by a distance between about 1 or 2 times the diameter of the rotating member 250, for example about 1, 1.5 or 2 times the diameter of the rotating member 250. This can help prevent certain undesired effects, such as in the case of pellets, ‘doming’ of the pellets within the chamber 220 or constriction of other types of dosage form. The length of the screw section 240 may be defined by the length of the screw thread 242, which may be between about 10 mm and about 30 mm, for example between about 10 mm and 20 mm.

Each exit tube 212 (where provided) may have a length of between about 5 mm and about 20 mm (optionally between about 10 mm and about 15 mm), wherein the length of the screw thread 242 in a direction along the longitudinal axis A of the chamber 220 may be at least the length of the exit tube 212 in the same direction, for example between about 1 and about 10 times the length of the exit tube 212, or about 1 to about 5 times the length of the exit tube 212, for example about 1.2, 1.3, 1.4, 1.5 or 2 times the length of the exit tube 212 (this is applicable to all aspects and embodiments including an exit tube 212).

The depth of each screw thread 242 may be between about 1 mm and about 3 mm. Alternatively, the depth of the screw thread 242 may be, in the case of a solid oral dosage form, tailored to a diameter thereof, such as a diameter of the pellets. For example, the depth of the screw thread 242 may be greater than the diameter of the pellets (or the smallest pellet contained in the chamber 220). Similarly, the height of the screw thread 242 can range from about 1 mm to about 10 mm, for example about 1 mm to about 4 mm.

The actuator 300, if provided with an electromechanical motor 302, may be configured to rotate a respective rotating member 250 at a rate of between about 50 rpm and about 500 rpm, optionally between about 90 rpm and about 150 rpm.

Although FIG. 1 shows an embodiment including two chambers 220 that are positioned side-by-side, more or fewer chambers 220 may be provided. A single chamber 220 could be used as described above. The two chambers 220 may or may not abut as shown and may be operated by a common actuator 300.

The actuator 300 may form part of a control unit (in any of the aspects or embodiments described herein), which may include an input device or user interface, which may include one or more buttons for operating the device 100. The control unit may comprise a control system configured to operate the various electrical and mechanical parts of the device 100, for example a user interface, display and dispensing mechanisms.

Aspects of the invention will now be described in relation to various embodiments of a device that is able to control the dispensing of an oral dosage form from one or more chambers, wherein the oral dosage form may be a solid, semisolid or liquid oral dosage form held in the chambers. The chambers may be part of a device 100 as described above (e.g., as shown in FIG. 1), in which a dispensing mechanism is incorporated into each chamber 220. However, the chambers could simply be cavities with no active dispensing mechanism within them, such that the oral dosage form simply falls, drips, or is otherwise dispensed out of a chamber due to, e.g., gravity. It should be noted that a semisolid and/or liquid oral dosage form could be held within the chambers, and dispensed using any suitable mechanism(s), e.g., by capillary forces.

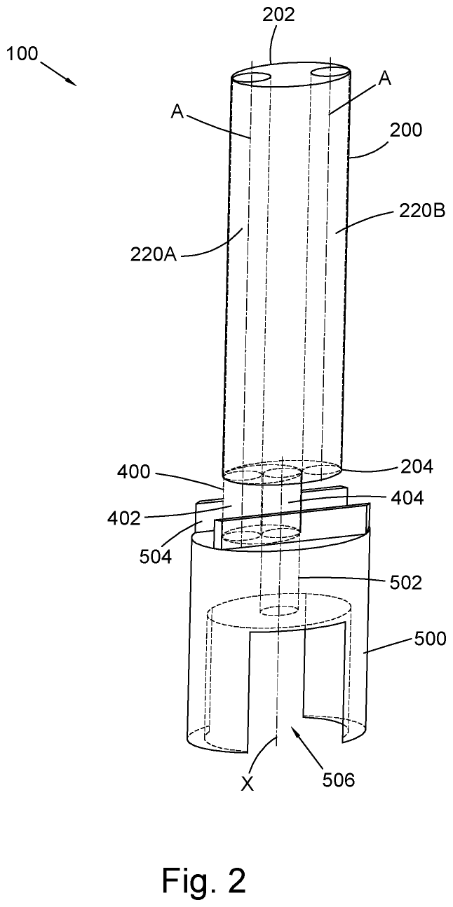

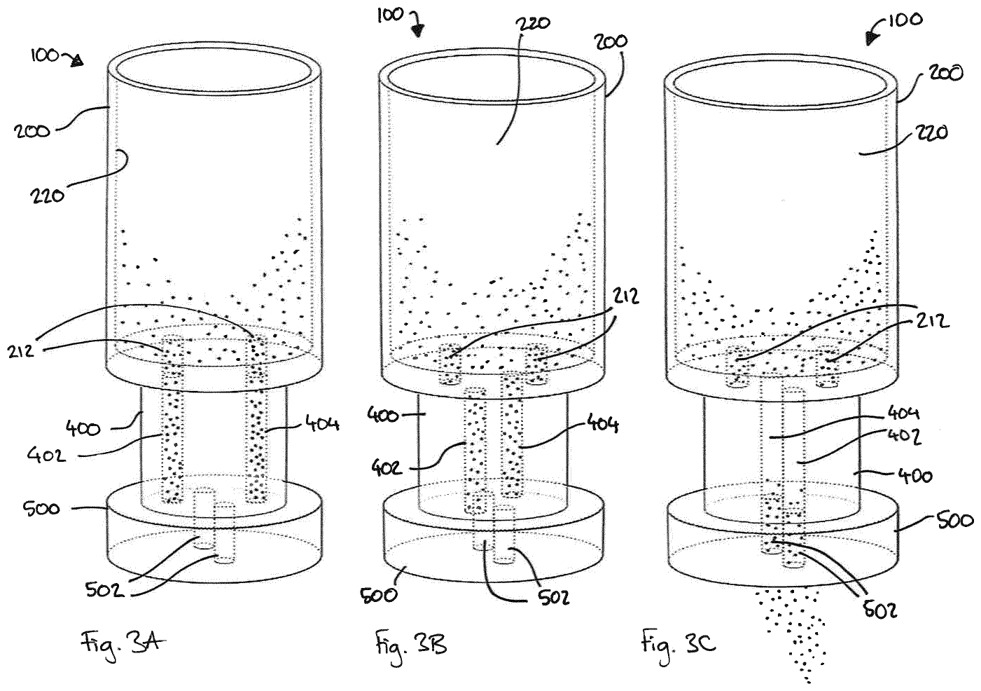

FIG. 2 shows an embodiment of a device 100, which may incorporate features of the device 100 shown in respect of FIG. 1, where like features are indicated with like reference numerals. It should be noted that FIG. 2 is highly schematic so as to indicate the operation of the device as will become apparent from the discussion below.

The device 100 of FIG. 2 comprises a cartridge 200 that incorporates two separate chambers 220A, 220B, each configured to store an oral dosage form. Each of the chambers 220A, 220B comprises a longitudinal axis A. The oral dosage form may be loaded into the chambers 220A, 220B at a first end 202 of the cartridge 200. A suitable cap (not shown) may be placed over the first end 202 to enclose the chambers 220A, 220B. The oral dosage form may then be configured to move to the second, dispensing end 204 of the cartridge 200 and may be dispensed therefrom by gravity. Alternatively, a dispensing mechanism, for example comprising an actuator 300 with rotating member 250, as well as a plunger 230 and/or screw pump 210, may be incorporated into the cartridge 200 in respect of each chamber 220A, 220B in order to move the oral dosage form towards the dispensing end 204 to be dispensed therefrom.

The device 100 comprises a movable member indicated in FIG. 2 at 400, which member 400 is operatively connected to the dispensing end 204 of the cartridge 200 and is configured to control movement of the oral dosage form to be dispensed from the cartridge 200 via the chambers 220A, 220B.

To do this, the member 400 comprises a first chamber 402 configured to selectively communicate with a first of the chambers 220A of the cartridge 200 and an outlet passage 502 of the device 100, wherein the member 400 is movable so that in a first position thereof the first chamber 402 is configured to receive the oral dosage form from the first of the chambers 220A, and in a second position thereof the first chamber 402 is configured to dispense the oral dosage form into the outlet passage 502. In the first position, the first chamber 402 may not be in communication with the outlet passage 502, and similarly, in the second position, the first chamber 402 may not be in communication with the first of the chambers 220A.

The member 400 further comprises a second chamber 404 configured to selectively communicate with a second of the chambers 220B of the cartridge 200 and the outlet passage 502 of the device 100, wherein the member 400 is movable so that in the first position thereof the second chamber 404 is configured to dispense the oral dosage form into the outlet passage 502, and in the second position the second chamber 404 is configured to receive the oral dosage form from the second of the chambers 220B. In the second position, the second chamber 404 may not be in communication with the outlet passage 502, and similarly, in the first position, the second chamber 404 may not be in communication with the second of the chambers 220B.

The outlet passage 502 may have a longitudinal axis X, which is offset from both of the axes A of the chambers 220A, 220B.

FIG. 2 shows the member 400 in its first position, wherein the member 400 may be movable (in this case slidable) between its first and second positions, for example slidable along a track 504 as shown. It will be appreciated that parts of the member 400 may not be shown in FIG. 2 for brevity. For example, the member 400 may comprise blocking plates that are configured to cover the outlet of one of the chambers 220A, 220B when the oral dosage form is dispensed from the other of the chambers 220A, 220B.

The outlet passage 502 and optional track 504 may form part of a cap 500. The outlet passage 502 may lead into a collection region 506 in the form of a cavity within the cap 500. The device 100 may further comprise a housing (not shown) that holds each of the cartridge 200, member 400 and cap 500 in position relative to each other, such that the member 400 can slide between its first and second positions as aforesaid whilst the cartridge 200 and cap 500 remain stationary. The housing may be configured to selectively enclose the collection region 506 so that the oral dosage form dispensed into the collection region is retained therein until it is required to be dispensed therefrom. Various selective enclosing mechanisms may be used, for example a lid, plug, stopper, etc.

The device 100 may have a more simple mechanism than is shown in FIGS. 1 and 2. For example, as shown in FIGS. 3A-C the device 100 may comprise a cartridge 200 having a single chamber 220 configured to store an oral dosage form (although multiple chambers could be provided instead). For convenience this is shown as a plurality of pellets in these figures, but as noted above the oral dosage form could be of a different type, such as a different type of solid dosage form, or a semisolid or liquid dosage form. The concept is substantially the same for whichever type of dosage form is used, and is similar to that described in respect of FIG. 2.

In the case of a semisolid or liquid dosage form, suitable fluid seals may be used between the various components, and especially the moving components, to prevent unwanted leakage from the various chambers and passages of the device 100.

The device 100 comprises a movable (in this case rotating) member 400 that comprises first and second chambers 402, 404. The single chamber 220 of the cartridge 200 comprises two separate outlets (e.g., exit tubes) 212, wherein pellets contained in the single chamber 220 of the cartridge 200 are configured to enter the exit tubes 212, e.g., via gravity.

The first and second chambers 402, 404 of the rotating member 400 are configured to move in and out of alignment with the exit tubes 212, such that at one point during rotation of the rotating member 400 the first and second chambers 402, 404 align with the exit tubes 212, such that an oral dosage form contained within the chamber 220 moves into the first and second chambers 402, 404 via the exit tubes 212. This position is shown in FIG. 3A.

The device 100 further comprises a substantially solid cap 500 having a pair of outlet passages 502 that are also configured to align with the first and second chambers 402, 404, but at a different rotational position of the rotating member 400 than the rotational position in which it aligns with the exit tubes 212. This means that upon rotation of the rotating member 400 from its position shown in FIG. 3A the oral dosage form contained within the first and second chambers 402, 404 will be retained therein, whilst the cap 500 will block the exit tubes 212 and prevent the oral dosage form from being dispensed from the chamber 220. This position is shown in FIG. 3B.

Upon further rotation of the rotating member 400, the first and second chambers 402, 404 will eventually align with the outlet passages 502, which causes the oral dosage form to fall or otherwise move out of the first and second chambers 402, 404 to be dispensed from the device 100. This position is shown in FIG. 3C.

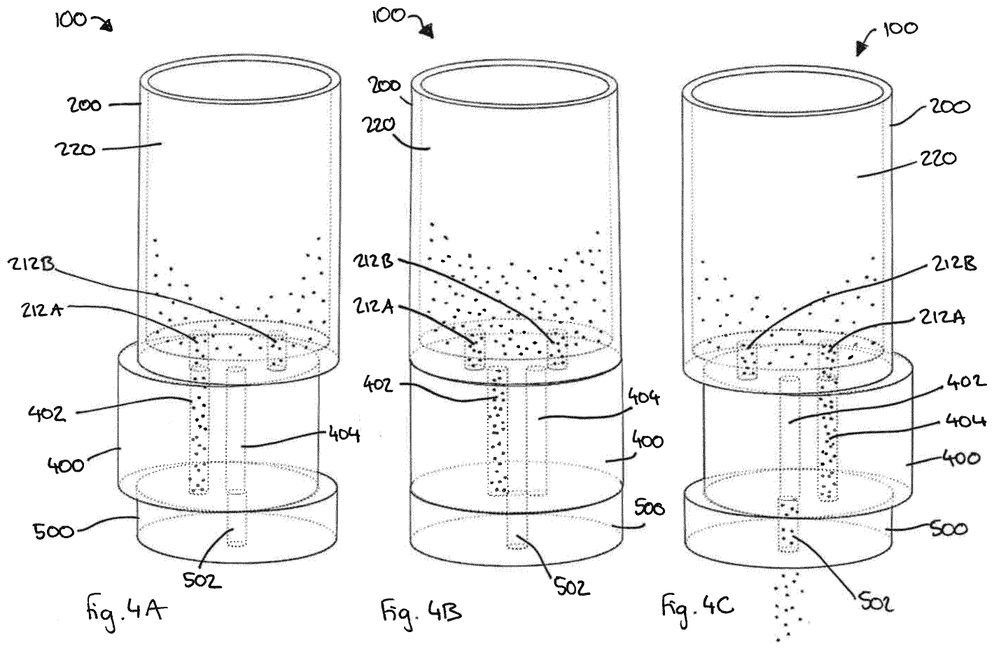

FIGS. 4A-C show an embodiment similar to that of FIGS. 3A-C, but wherein the movable member 400 slides between its first and second positions in a manner similar to that described in respect of FIG. 2.

In this embodiment the cartridge 200 is substantially the same as that of FIGS. 3A-C, that is comprising a single chamber 220 and a pair of outlets (e.g., exit tubes) 212. The cap 500 comprises a single outlet passage 502 instead of dual outlet passages as shown in the previous embodiment.

The sliding member 400 comprises a first chamber 402 configured to selectively communicate with a first of the exit tubes 212A of the cartridge 200 and the outlet passage 502 of the cap 500, wherein the member 400 is movable so that in a first position thereof the first chamber 402 is configured to receive the oral dosage form from the first of the exit tubes 212A, and in a second position thereof the first chamber 402 is configured to dispense the oral dosage form into the outlet passage 502. In the first position, the first chamber 402 may not be in communication with the outlet passage 502, and similarly, in the second position, the first chamber 402 may not be in communication with the first of the exit tubes 212A.

The member 400 further comprises a second chamber 404 configured to selectively communicate with a second of the exit tubes 212B of the cartridge 200 and the outlet passage 502 of the device 100, wherein the member 400 is movable so that in the first position thereof the second chamber 404 is configured to dispense the oral dosage form into the outlet passage 502, and in the second position the second chamber 404 is configured to receive the oral dosage form from the second of the exit tubes 212B. In the second position, the second chamber 404 may not be in communication with the outlet passage 502, and similarly, in the first position, the second chamber 404 may not be in communication with the second of the exit tubes 212B.

FIG. 4A shows the sliding member 400 in its first position, such that the oral dosage form may be dispensed from the chamber 220 of the cartridge 200 into the first chamber 402 via the first exit tube 212A. The second exit tube 212B is blocked by the member 400, such that the oral dosage form cannot be dispensed therefrom.

The sliding member 400 may be movable to an intermediate position between the first and second positions, as shown in FIG. 4B. In this position neither of the first chamber 402 nor the second chamber 404 are aligned with either exit tube 212A, 212B, or the outlet passage 502. As such, the oral dosage form retained within the first chamber 402 remain within the first chamber 402, whilst the oral dosage form is not permitted to pass through from the chamber 220 of the cartridge 200 to the outlet passage 502.

FIG. 4C shows the sliding member 400 in its second position, such that the oral dosage form may be dispensed from the first chamber 402 via the outlet passage 502. Also in this position, the oral dosage form will not be dispensed from the chamber 220 of the cartridge 200 into the second chamber 404 via the second exit tube 212B. The first exit tube 212A is blocked by the member 400, such that the oral dosage form cannot be dispensed therefrom.

The sliding member 400 may be moved back to its first position, via the intermediate position, to continue to permit the oral dosage form to be dispensed from the device 100 in a controlled manner.

It will be appreciated that FIGS. 2 and 4A-C show similar arrangements, but whilst the embodiment shown in respect of FIG. 2 uses separate chambers 220A, 220B to feed each of the first and second chambers 402, 404 of the movable member 400, that of FIGS. 4A-C uses a common chamber 222 feed both first and second chambers 402, 404 of the movable member 400 (although separate chambers could be provided if desired). The overall principle in both arrangements is the same, namely to provide a way of controlling the dispensing of the oral dosage form from the cartridge 200 to a user.

The embodiment of FIG. 2 could be used to provide different/separate medicaments in each respective chamber 220A, 220B, such that each different/separate medicament could be dispensed sequentially, as well as in controlled amounts corresponding to the volume of the first and second chambers 402, 404 of the movable member 400. In this manner the device 100 can be configured to control the dispensing of two different medications in specific amounts. The volume of the first and/or second chamber 402, 404 could correspond to a particular dosage of the medication held within either chamber.

The embodiment of FIGS. 4A-C could be used to provide a simple mechanism for dispensing an oral dosage form from a single chamber 220 in controlled amounts corresponding to the volume of the first and second chambers 402, 404 of the movable member 400. That is, the combined volume of the first and second chambers 402, 404 could correspond to a particular dosage of the medication held within the common chamber.

It will be appreciated that the embodiment of FIGS. 3A-C operates in a manner substantially similar to that of FIGS. 4A-C, although the movable member 400 is configured to rotate rather than slide between its first and second positions. It is further envisaged that the embodiment of FIGS. 3A-C could be used with a cartridge 200 having separate chambers 220A, 220B to feed each of the first and second chambers 402, 404 of the movable member 400, in a similar manner to that described in respect of FIGS. 4A-C.

It is envisaged that different dose sizes could be dispensed using the embodiments of FIGS. 3A-C or FIGS. 4A-C by rotating or sliding the movable member 400 multiple times. For example, rotating the member 400 of FIGS. 3A-C by 720 degrees would mean that a dose could be dispensed having a volume of twice the combined volume of the first and second chambers 402, 404.

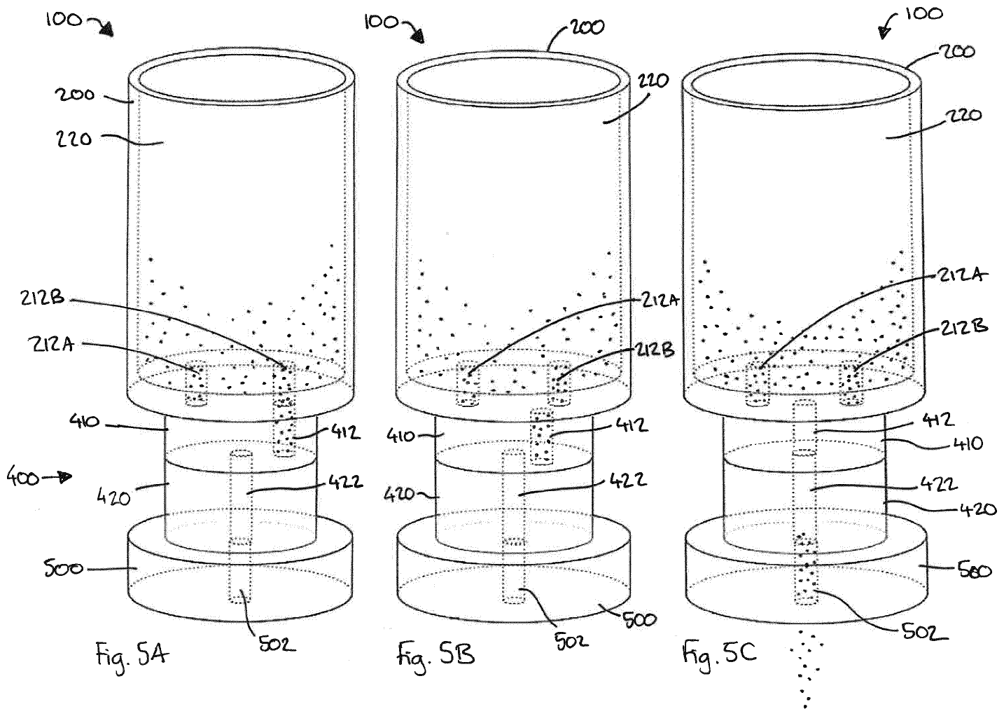

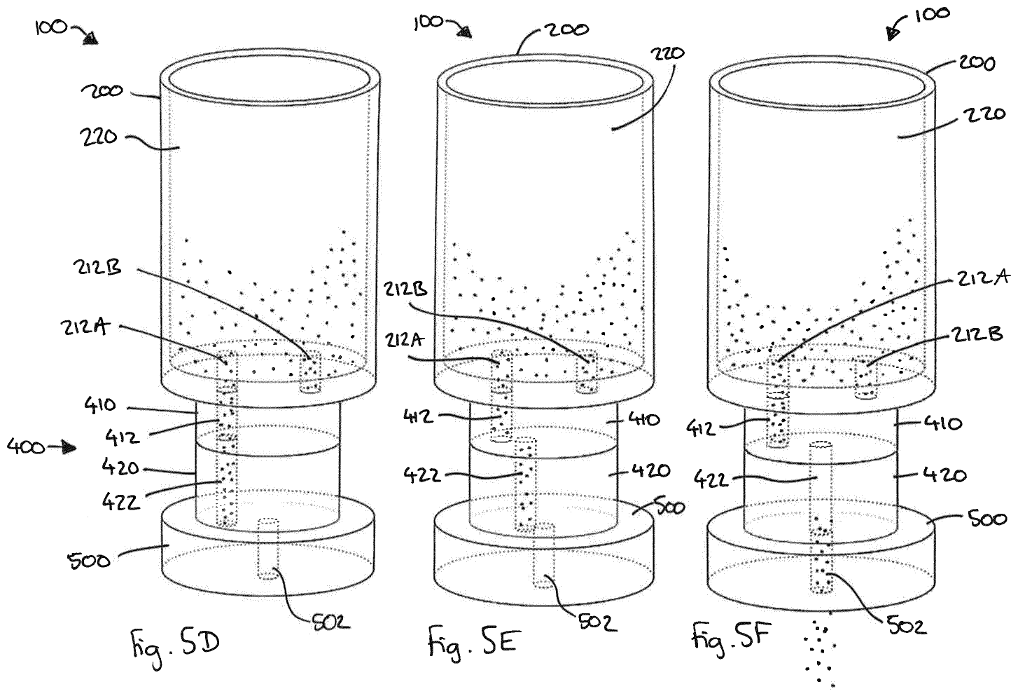

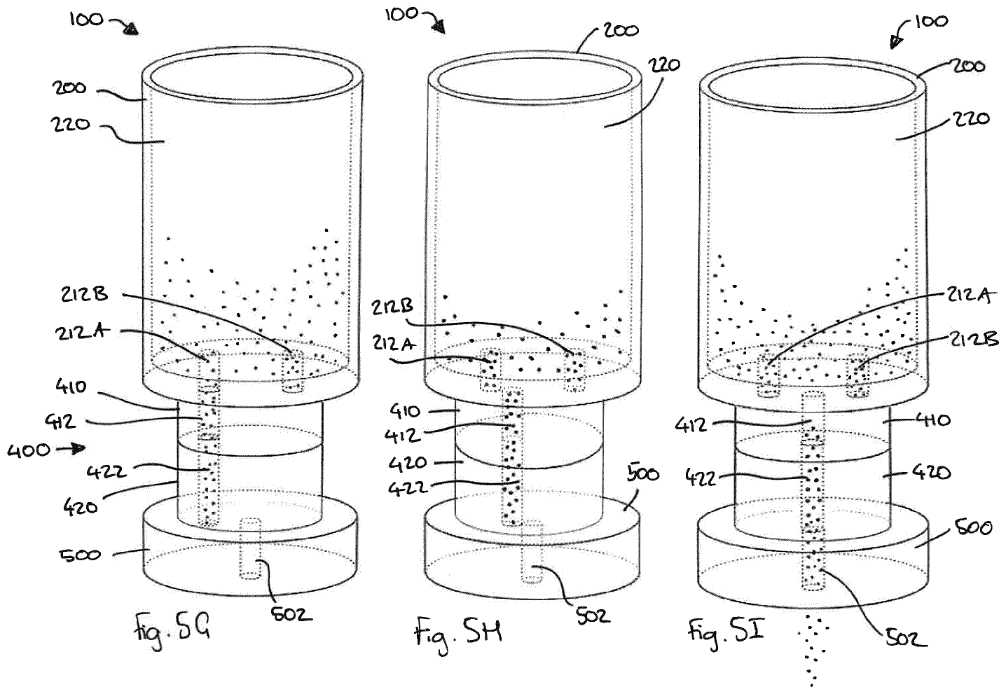

FIGS. 5A-C, 5D-F and 5G-I illustrate an embodiment comprising a movable member 400 that is split into separate pieces that are movable relative to each other, which enables the same device 100 to dispense different dose sizes (without, e.g., having to rotate or slide a member multiple times) as will be described in more detail below.

Referring first to FIG. 5A, this shows a device 100 comprising a cartridge 200 and chamber 220 configured to hold an oral dosage form. The chamber 220 comprises first and second exit tubes 212A, 212B, as well as a cap 500 comprising a single outlet passage 502. In this manner the device 100 is similar to that described in respect of FIGS. 4A-C.

However, the device of FIG. 5A comprises a movable member 400 having a first rotatable portion 410 and a second rotatable portion 420, wherein the first and second portions 410, 420 are rotatable relative to each other. The first portion 410 comprises a first chamber 412 that is configured to align with one or other of the first and second exit tubes 212A, 212B depending on the rotational position of the first portion 410. The second portion 420 comprises a second chamber 422 that is configured to align with the first chamber 412 at a given point in its rotation. The second chamber 422 is also configured to align with one or other of the first and second exit tubes 212A, 212B depending on the rotational position of the second portion 420.

The first and second portions 410 may be aligned with the first exit tube 212A or the second exit tube 212B as desired. For example, if the first exit tube 212A is associated with a different chamber of the cartridge 200 than the second exit tube 212B as is possible with various embodiments described herein.

FIGS. 5A-C illustrate a first sequence, in which FIG. 5A shows the movable member 400 configured so that the first chamber 412 is aligned with the second exit tube 212B, such that the oral dosage form enters the first chamber 412 from the chamber 220 of the cartridge 200 via the second exit tube 212B. In this position the second chamber 422 is not aligned with the first chamber 412, such that the oral dosage form is not conveyed further.

The first portion 410 of the movable member 400 may be rotated from its position shown in FIG. 5A to the position shown in FIG. 5B, wherein the first chamber 412 is no longer aligned with the second exit tube 212B and the oral dosage form cannot enter the first chamber 412 from the chamber 220 of the cartridge 200. In addition, the first chamber 412 is still not aligned with the second chamber 422, such that the oral dosage form cannot be conveyed from the first chamber 412. It will be appreciated that the first chamber 412 has a given volume, and the oral dosage form within the first chamber 412 may correspond to a first volume based dosage.

In order to dispense the oral dosage form from the first chamber 412, the first portion 410 may be rotated from its position shown in FIG. 5B to the position shown in FIG. 5C, wherein the first chamber 412 is aligned with the second chamber 422, such that the oral dosage form passes from the first chamber 412 to the second chamber 422. As the second chamber 422 is aligned with the outlet passage 502, the oral dosage form is conveyed straight through the second chamber 422 to be dispensed from the device 100 to a user.

Accordingly, using the first sequence of FIGS. 5A-C a first dosage may be dispensed from the device 100 corresponding to the volume of the first chamber 412.

FIGS. 5D-F illustrates a second sequence, in which FIG. 5D shows both the first and second chambers 412, 422 of the movable member 400 aligned with the first exit tube 212A, such that the oral dosage form is dispensed from the chamber 220 of the cartridge 200 into both the first and second chambers 412, 422 at the same time via the first exit tube 212A.

The second portion 420 of the movable member 400 may be rotated from its position shown in FIG. 5D to the position shown in FIG. 5E, wherein the second chamber 422 is no longer aligned with the first chamber 412 or the first exit tube 212A, such that the oral dosage form cannot enter the second chamber 422 from the chamber 220 of the cartridge 200, or the first chamber 412 of the movable member 400. In addition, the second chamber 422 is still not aligned with the outlet passage 502, such that the oral dosage form cannot be dispensed from the device 100. It will be appreciated that the second chamber 422 has a given volume, and the oral dosage form within the second chamber 422 may correspond to a second volume based dosage.

In order to dispense the oral dosage form from the second chamber 422, the second portion 420 may be rotated from its position shown in FIG. 5E to the position shown in FIG. 5F, wherein the second chamber 422 is now aligned with the outlet passage 502, such that the oral dosage form is conveyed from the second chamber 422 to be dispensed from the device 100 to a user.

Accordingly, using the second sequence of FIGS. 5D-F a second dosage may be dispensed from the device 100 corresponding to the volume of the second chamber 422. Since the volume of the second chamber 422 is larger than the volume of the first chamber 412, the second dosage will be larger than the first dosage (corresponding to the volume of the first chamber 412).

FIGS. 5G-I illustrate a third sequence, in which FIG. 5G shows (similarly to FIG. 5D) both the first and second chambers 412, 422 of the movable member 400 aligned with the first exit tube 212A, such that the oral dosage form is dispensed from the chamber 220 of the cartridge 200 into both the first and second chambers 412, 422 at the same time via the first exit tube 212A.

In this sequence, both the first and second portions 410, 420 of the movable member 400 may be rotated from their positions shown in FIG. 5G to the positions shown in FIG. 5H, wherein the first and second chambers 412, 422 remain aligned with each other, but are no longer aligned with the first exit tube 212A, such that the oral dosage form cannot enter the combined volume of the first and second chambers 412, 422 from the chamber 220 of the cartridge 200. In addition, the first and second chambers 412, 422 are not aligned with the outlet passage 502, such that the oral dosage form cannot be dispensed from the device 100. It will be appreciated that the first and second chambers 412, 422 have a given, combined volume and the oral dosage form within the first and second chambers 412, 422 may correspond to a third volume based dosage.

In order to dispense the oral dosage form from the first and second chambers 412, 422, the first and second portions 410, 420 may be rotated from their positions shown in FIG. 5H to the positions shown in FIG. 5I, wherein the first and second chambers 412, 422 remain aligned with each other, and are now both aligned with the outlet passage 502, such that the oral dosage form is conveyed from both the first and second chambers 412, 422 to be dispensed from the device 100 to a user.

Accordingly, using the third sequence of FIGS. 5G-I a third dosage may be dispensed from the device 100 corresponding to the volume of both the first and second chambers 412, 422. Since the volume of both the first and second chambers 412, 422 is larger than the volume of either the first or the second chambers 412, 422 separately, the third dosage will be larger than both the first and second dosages (corresponding respectively to the volumes of the first and second chambers 412, 422).

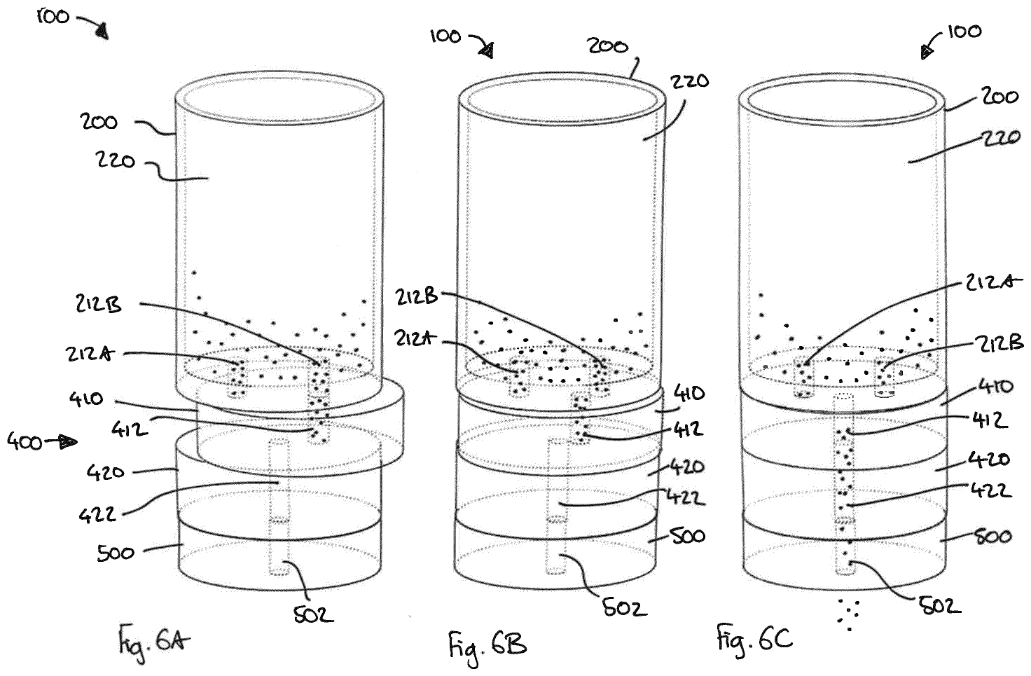

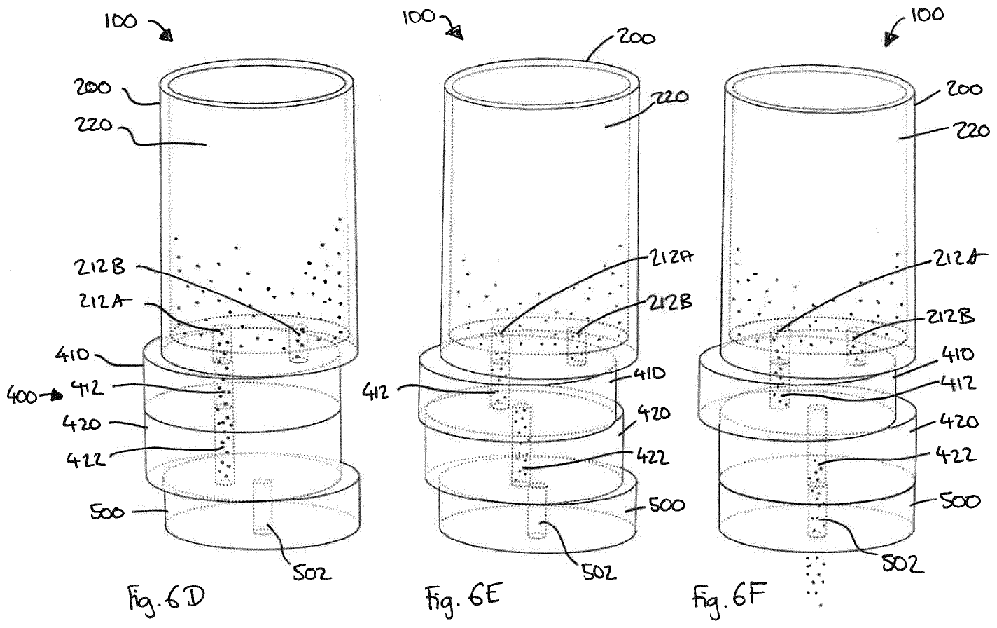

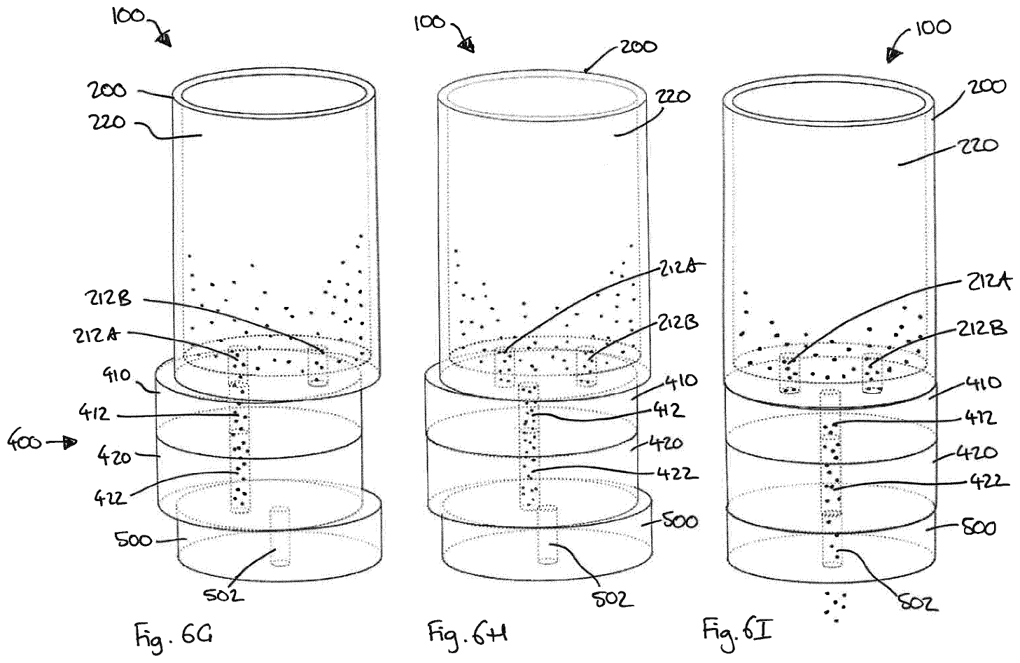

FIGS. 6A-C, 6D-F and 6G-I illustrate an embodiment similar to that of FIGS. 5A-C, 5D-F and 5G-I respectively, but comprising a movable member 400 in which the first and second portions 410, 420 are slidable relative to each other, rather than rotatable. That is, a movable member 400 is split into separate pieces 410, 420 that are movable (in this case slidable) relative to each other, which enables the same device 100 to dispense different dose sizes in a similar manner to that described above in respect of FIGS. 5A-C, 5D-F and 5G-I.

Referring first to FIG. 6A, this shows a device 100 comprising a cartridge 200 and chamber 220 configured to hold an oral dosage form. The chamber 220 comprises first and second exit tubes 212A, 212B, as well as a cap 500 comprising a single outlet passage 502. In this manner the device 100 is similar to that described in respect of FIGS. 4A-C and 5A-I.

However, the device of FIG. 6A comprises a movable member 400 having a first slidable portion 410 and a second slidable portion 420, wherein the first and second portions 410, 420 are slidable/translatable relative to each other. The first portion 410 comprises a first chamber 412 that is configured to align with one or other of the first and second exit tubes 212A, 212B depending on the position of the first portion 410 along its sliding axis. The second portion 420 comprises a second chamber 422 that is configured to align with the first chamber 412 at a given point in its translation. The second chamber 422 is also configured to align with one or other of the first and second exit tubes 212A, 212B depending on the position of the second portion 420 along its sliding axis.

The first and second portions 410, 420 may be aligned with the first exit tube 212A or the second exit tube 212B as desired. For example, if the first exit tube 212A is associated with a different chamber of the cartridge 200 than the second exit tube 212B, as is possible with various embodiments described herein, then a user may wish to align the first and/or second portion 410, 420 with the first exit tube 212A rather than the second exit tube 212B.

FIGS. 6A-C illustrate a first sequence, in which FIG. 6A shows the movable member 400 configured so that the first chamber 412 is aligned with the second exit tube 212B, such that the oral dosage form enters the first chamber 412 from the chamber 220 of the cartridge 200 via the second exit tube 212B. In this position the second chamber 422 is not aligned with the first chamber 412, such that the oral dosage form is not conveyed further.

The first portion 410 of the movable member 400 may be translated from its position shown in FIG. 6A to the position shown in FIG. 6B, wherein the first chamber 412 is no longer aligned with the second exit tube 212B and the oral dosage form cannot enter the first chamber 412 from the chamber 220 of the cartridge 200. In addition, the first chamber 412 is still not aligned with the second chamber 422, such that the oral dosage form cannot be conveyed from the first chamber 412. It will be appreciated that the first chamber 412 has a given volume, and the oral dosage form within the first chamber 412 may correspond to a first volume based dosage.

In order to dispense the oral dosage form from the first chamber 412, the first portion 410 may be translated from its position shown in FIG. 6B to the position shown in FIG. 6C, wherein the first chamber 412 is aligned with the second chamber 422, such that the oral dosage form passes from the first chamber 412 to the second chamber 422. As the second chamber 422 is aligned with the outlet passage 502, the oral dosage form is conveyed straight through the second chamber 422 to be dispensed from the device 100 to a user.

Accordingly, using the first sequence of FIGS. 6A-C a first dosage may be dispensed from the device 100 corresponding to the volume of the first chamber 412.

FIGS. 6D-F illustrates a second sequence, in which FIG. 6D shows both the first and second chambers 412, 422 of the movable member 400 aligned with the first exit tube 212A, such that the oral dosage form is dispensed from the chamber 220 of the cartridge 200 into both the first and second chambers 412, 422 at the same time via the first exit tube 212A.

The second portion 420 of the movable member 400 may be translated from its position shown in FIG. 6D to the position shown in FIG. 6E, wherein the second chamber 422 is no longer aligned with the first chamber 412 or the first exit tube 212A, such that the oral dosage form cannot enter the second chamber 422 from the chamber 220 of the cartridge 200, or the first chamber 412 of the movable member 400. In addition, the second chamber 422 is still not aligned with the outlet passage 502, such that the oral dosage form cannot be dispensed from the device 100. It will be appreciated that the second chamber 422 has a given volume, and the oral dosage form within the second chamber 422 may correspond to a second volume based dosage.

In order to dispense the oral dosage form from the second chamber 422, the second portion 420 may be translated from its position shown in FIG. 6E to the position shown in FIG. 6F, wherein the second chamber 422 is now aligned with the outlet passage 502, such that the oral dosage form is conveyed from the second chamber 422 to be dispensed from the device 100 to a user.

Accordingly, using the second sequence of FIGS. 6D-F a second dosage may be dispensed from the device 100 corresponding to the volume of the second chamber 422. Since the volume of the second chamber 422 is larger than the volume of the first chamber 412, the second dosage will be larger than the first dosage (corresponding to the volume of the first chamber 412).

FIGS. 6G-I illustrate a third sequence, in which FIG. 6G shows (similarly to FIG. 6D) both the first and second chambers 412, 422 of the movable member 400 aligned with the first exit tube 212A, such that the oral dosage form is dispensed from the chamber 220 of the cartridge 200 into both the first and second chambers 412, 422 at the same time via the first exit tube 212A.

In this sequence, both the first and second portions 410, 420 of the movable member 400 may be translated from their positions shown in FIG. 6G to the positions shown in FIG. 6H, wherein the first and second chambers 412, 422 remain aligned with each other, but are no longer aligned with the first exit tube 212A, such that the oral dosage form cannot enter the combined volume of the first and second chambers 412, 422 from the chamber 220 of the cartridge 200. In addition, the first and second chambers 412, 422 are not aligned with the outlet passage 502, such that the oral dosage form cannot be dispensed from the device 100. It will be appreciated that the first and second chambers 412, 422 have a given, combined volume and the oral dosage form within the first and second chambers 412, 422 may correspond to a third volume based dosage.

In order to dispense the oral dosage form from the first and second chambers 412, 422, the first and second portions 410, 420 may be translated from their positions shown in FIG. 6H to the positions shown in FIG. 6I, wherein the first and second chambers 412, 422 remain aligned with each other, and are now both aligned with the outlet passage 502, such that the oral dosage form is conveyed from both the first and second chambers 412, 422 to be dispensed from the device 100 to a user.

Accordingly, using the third sequence of FIGS. 6G-I a third dosage may be dispensed from the device 100 corresponding to the volume of both the first and second chambers 412, 422. Since the volume of both the first and second chambers 412, 422 is larger than the volume of either the first or the second chambers 412, 422 separately, the third dosage will be larger than both the first and second dosages (corresponding respectively to the volumes of the first and second chambers 412, 422).

It will be appreciated that various modifications may be made to the embodiments described above whilst still falling within the broadest aspects of the present disclosure. For example, although two separate exit tubes 212A, 212B are shown, which may provide a greater degree of flexibility and redundancy, a single exit tube may be provided whilst still allowing different dosages to be dispensed from the device 100. Similarly, and as noted previously, the single chamber 220 may be split into multiple chambers, e.g., two separate chambers, wherein each of the multiple chambers comprises an exit tube configured to convey an oral dosage form from the respective chamber to either or both of the first and second chambers 412, 402 of the movable member 400.

References herein to the various tubes, chambers or passages being “aligned with” one another may be interpreted as being in communication with one another such that the oral dosage form may be conveyed from one to the other, e.g., via gravity or using a suitable dispensing mechanism.

The cap 500 (or an additional cap to be placed over the cap 500) may comprise a collection region, for example in the form of a cavity within the cap 500. The device 100 may further comprise a housing (not shown) that holds each of the cartridge 200, member 400 and cap 500 (and additional cap if provided) in position relative to each other, such that the portions 410, 420 of the member 400 can rotate or slide between their described positions as aforesaid, whilst the cartridge 200 and cap 500 (and additional cap if provided) remain stationary. The housing may be configured to selectively enclose the collection region so that an oral dosage form dispensed into the collection region is retained therein until required to be dispensed therefrom. Alternatively, or additionally a cover, lid, plug, etc. could be placed over the outlet passage 502, which is configured to retain the oral dosage form within the outlet passage 502 until it is required to be dispensed therefrom.

The movement of the movable member 400 in any of the embodiments described above may be controlled and effectuated by an actuator, which may form part of a control system and/or control unit as described elsewhere herein. The actuator may be configured to slide or rotate the movable member 400, or its portions 410, 420 as described above in order to dispense a dose of one or more medicaments contained in the cartridge 200. The actuator may be electrically driven using one or more electric motors.

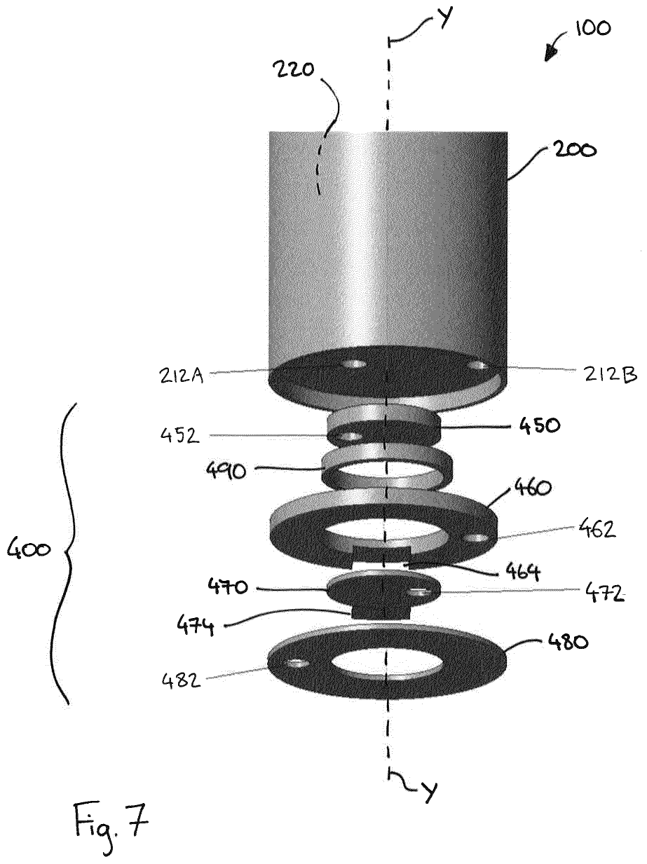

FIG. 7 shows an embodiment of a device 100 in which a movable member 400 is split into multiple component parts such that, when rotated in a first direction, the member 400 dispenses a medication from a first exit tube 212A, and when rotated in a second, opposite direction, the member 400 dispenses a medication from a second, different exit tube 212B.

The device 100 may incorporate features of the device 100 shown in respect of FIG. 1, where like features are indicated with like reference numerals. It should be noted that FIG. 7 is highly schematic and is intended merely to indicate the operation of the device as will become apparent from the discussion below.

The device 100 comprises a cartridge 200 having a chamber 220 for storing an oral dosage form, which chamber 220 comprises a first outlet (e.g., exit tube) 212A and a second outlet (e.g., exit tube) 212B. The first exit tube 212A is located at a position that is radially inward of the second exit tube 212B with respect to the longitudinal axis Y of the device 100.

The device 100 further comprises a movable (in this case rotatable) member 400 having a first, rotatable plate 450 that is configured to rotate in use. The first plate 450 comprises a first chamber 452 configured to align with the first exit tube 212A at a particular rotational position thereof. The member 400 may be rotatable about the longitudinal axis Y of the device 100, as shown in FIG. 7.

The member 400 further comprises a second, rotatable plate 460 that is configured to rotate in use, wherein the second plate 460 comprises a second chamber 462 that is configured to align with the second exit tube 212B at a particular rotational position thereof.

The member 400 further comprises a third plate 470 that is configured to rotate with the second plate 460. The third plate 470 comprises an aperture 472, wherein the first chamber 452 of the first plate 450 is configured to align with the aperture 472 at a particular rotational position of the first plate 450. Upon alignment of the first chamber 452 with the aperture 472, an oral dosage form may be dispensed from the first chamber 452 from the device 100 via the aperture 472 of the third plate 470. In order to ensure that the third plate 470 rotates with the second plate 460, a tooth 474 of the third plate 470 may slot within a cavity 464 of the second plate 460, wherein the cooperation of the tooth 474 and the cavity 464 locks the third plate 470 in position with respect to the second plate 460.

The member 400 further comprises a fourth plate 480 that is fixed in position with respect to the cartridge 200 and may not rotate in use. The fourth plate 480 comprises an aperture 482, wherein the second chamber 462 of the second plate 460 is configured to align with the aperture 482 at a particular rotational position of the second plate 460. Upon alignment of the second chamber 462 with the aperture 482, the oral dosage form may be dispensed from the second chamber 462 (and potentially from the device 100, or into a cap/collection region) via the aperture 482 of the fourth plate 480.

The first plate 450 may be positioned radially within the second plate 460, and a one-way bearing indicated at 490 may be positioned between (e.g., radially between) the first and second plates 450, 460. The one-way bearing 490 may be configured to permit the first plate 450 to rotate relative to, and independently of the second plate 460 when the first plate 450 is rotated in a first rotational direction (e.g., one of clockwise and counter-clockwise), wherein the one-way bearing 490 is further configured to lock the first plate 450 in position relative to the second plate 460 such that it does not rotate relative to, or independently of the second plate 460 when the first plate 450 and/or the second plate 460 is/are rotated in a second, opposite rotational direction (e.g., the other of clockwise and counter-clockwise).

Accordingly, the device 100 may be operated such that a first volume-based dose may be dispensed from the first chamber 452 of the first plate 450 via the first exit tube 212A and aperture 472 of the third plate 470. The first dose may correspond in volume to the size of the first chamber 452 of the first plate 450, and may be dispensed by rotating only the first plate 450 relative to the other parts of the member 400.

The device 100 may be further operated such that a second volume-based dose may be dispensed, this time from the second chamber 462 of the second plate 460 via the second exit tube 212B and aperture 482 of the fourth plate 480. The second dose may correspond in volume to the size of the second chamber 462 of the second plate 460, and may be dispensed by rotating both the first plate 450 and the second plate 460 in the configuration where the first plate 450 is locked in position relative to the second plate 460. In this configuration, the first plate 450 will rotate at the same rate as the third plate 470, such that the first chamber 452 cannot align with the aperture 472 of the third plate 470. This means that the oral dosage form cannot be dispensed from the first chamber 452.

It will be appreciated that the size of the first and second chambers 452, 462 can be configured such that the first and second volume-based dosages can be different. In embodiments in which the chamber 220 is a single chamber serving both the first and second exit tubes 212A, 212B, this can allow different volume-based dosages of the same medication contained within the single chamber 220.

It is envisaged that the chamber 220 may be split into first and second chambers 220A, 220B that each serve respective first and second exit tubes 212A, 212B, similar to the embodiment of FIG. 2 described above. In this situation, the first and second chambers 452, 462 of the movable member 400 may be of the same volume, and configured to dispense different medicaments contained in the first and second chambers 220A, 220B. The first and second chambers 452, 462 of the movable member 400 may still be of a different volume, and configured to dispense different medicaments in different volumes.

A cap, lid or plug (which may be removable/replaceable) may be placed over the fourth plate 480, which comprises a collection region, for example in the form of a cavity. The device 100 may further comprise a housing (not shown) that holds each of the cartridge 200, member 400 and cap in position, lid or plug relative to each other, such that the various parts of the member 400 can rotate as aforesaid, whilst the cartridge 200 and cap, lid or plug (if provided) remain stationary. The housing may be configured to selectively enclose the collection region so that an oral dosage form dispensed into the collection region is retained therein until required to be dispensed therefrom. Alternatively, or additionally a cover or plug could be placed over the apertures 472, 482 of the third and fourth plates 470, 480, which is configured to retain an oral dosage form within the outlet passage 502 until required to be dispensed therefrom.

The rotational movement described above in respect of FIG. 7 may be controlled and effectuated by an actuator, which may form part of a control system and/or control unit as described elsewhere herein. The actuator may be configured to rotate the first plate 450, such that rotation of the first plate 450 in the first rotational direction as described above causes rotation only of the first plate 450 (due to the one-way bearing 490), and rotation of the first plate 450 in the second rotational direction causes rotation of both the first plate 450, bearing 490, second plate 460 and third plate 470. To permit this a shaft (not shown) may extend through the cartridge 200, which shaft may be configured to rotate the first plate 450 in this manner. The shaft may be operatively connected to the actuator, which may comprise, e.g., an electric motor configured to rotate the shaft.

It is envisaged that several layers of similar plates could be provided in the movable member 400 of this embodiment such that different dosing volumes could be provided.

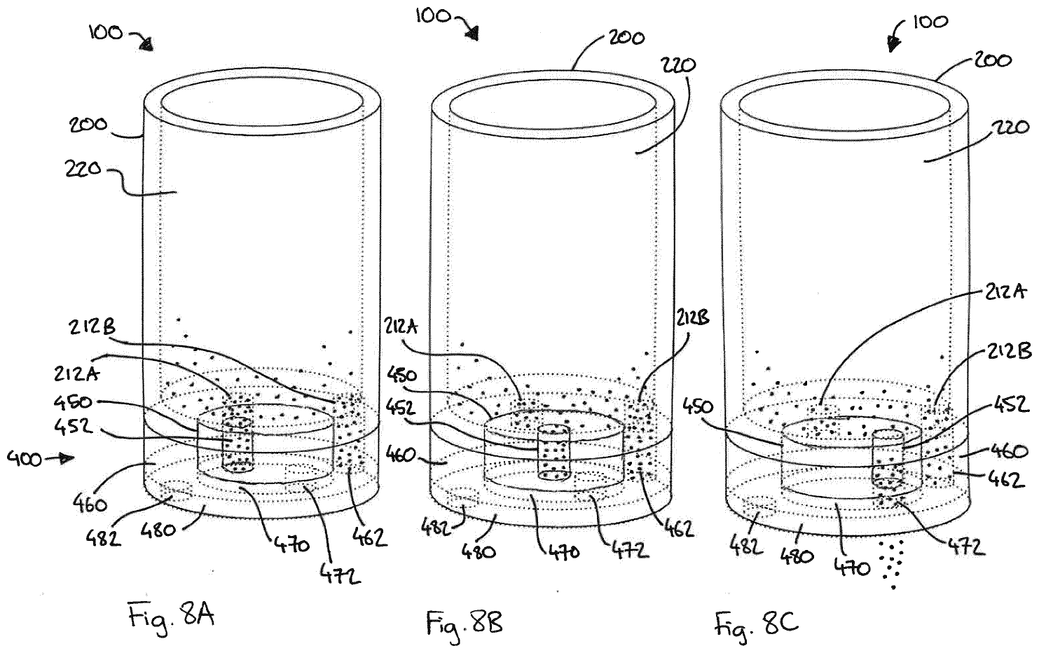

FIGS. 8A-F illustrate (schematically) the embodiment of FIG. 7 and the sequence of rotations that may be used to dispense an oral dosage form from the device 100.

FIGS. 8A-C show a first sequence that may be used to rotate the first plate 450 and dispense a first dose of medicament. The device 100 is shown as comprising a cartridge 200 having a chamber 220 that services first and second outlets (e.g., exit tubes) 212A, 212B as described above. A movable member 400 is also provided having a first plate 450 with a first chamber 452 indicated in FIGS. 8A-C in solid lines to distinguish it from the rest of the components thereof.

FIGS. 8A-C further show the second plate 460, third plate 470 and fourth plate 480 in dotted lines, as well as respectively the second chamber 462, aperture 472 and aperture 482 thereof.

FIG. 8A shows the first plate 450 at a first rotational position in which the first chamber 452 thereof is aligned with the first exit tube 212A, such that the oral dosage form is dispensed from the chamber 220 of the cartridge 200 into the first chamber 452 of the member 400 via the first exit tube 212A. As the first chamber 452 is not aligned with the aperture 472 of the third plate 470 in this position, the oral dosage form is not dispensed further from, and remains within the first chamber 452.

The first plate 450 may be rotated in a first rotational direction to the position shown in FIG. 8B, in which the first chamber 452 is no longer aligned with the first exit tube 212A and the oral dosage form cannot enter the first chamber 452 from the chamber 220 of the cartridge 200. In addition, the first chamber 452 is still not aligned with the aperture 472 of the third plate 470, such that the oral dosage form cannot be conveyed from the first chamber 452.

In order to dispense the oral dosage form from the first chamber 452, the first plate 450 may be rotated further in the same direction from its position shown in FIG. 8B to the position shown in FIG. 8C, in which the first chamber 452 is aligned with the aperture 472 of the third plate 470, such that the oral dosage form passes from the first chamber 452 and is conveyed through the aperture 472 of the third plate 470 to be dispensed from the device 100 to a user.

Accordingly, using the sequence of FIGS. 8A-C a first dosage may be dispensed from the device 100 corresponding to the volume of the first chamber 412.

FIGS. 8D-F show a second sequence that may be used to rotate both the first plate 450 and the second plate 460 in order to dispense a second dose of medicament. In these figures, for illustrative purposes the second plate 460 and its chamber 462 are shown in solid lines, whilst the first plate 450, third plate 470 and fourth plate 480 are shown in dotted lines, as well as respectively the first chamber 452, aperture 472 and aperture 482 thereof.

FIG. 8D shows the first and second plates 450, 460 at a first rotational position (which is similar to that of FIG. 8A), in which the first chamber 452 is aligned with the first exit tube 212A and the second chamber 462 is aligned with the second exit tube 212B, such that the oral dosage form is dispensed from the chamber 220 of the cartridge 200 into the second chamber 462 of the member 400 via the second exit tube 212B. As the second chamber 452 is not aligned with the aperture 482 of the fourth plate 470 in this position, the oral dosage form is not dispensed further from, and remains within the second chamber 462.

The first plate 450 may be rotated in a second rotational direction (opposite to the first rotational direction) to the position shown in FIG. 8E, which also causes rotation of the second plate 460 and second chamber 462, as well as the third plate 470 and its aperture 472. Accordingly, the second chamber 462 is no longer aligned with the second exit tube 212B and the oral dosage form cannot enter the second chamber 462 from the chamber 220 of the cartridge 200. In addition, the second chamber 462 is still not aligned with the aperture 482 of the fourth plate 480, such that the oral dosage form cannot be conveyed from the second chamber 462.

Furthermore, the first chamber 452 is not aligned with the aperture 472 of the third plate 470, due to their rotating together in the second rotational direction as a result of the one-way bearing 490 (not shown in these figures for brevity), such that the oral dosage form cannot be conveyed from the first chamber 452 either.

In order to dispense the oral dosage form from the second chamber 462, the first plate 450 may be rotated further in the same direction from its position shown in FIG. 8E to the position shown in FIG. 8F, which causes rotation of the second plate 460 such that the second chamber 462 is aligned with the aperture 482 of the fourth plate 480. This means that the oral dosage form passes from the second chamber 462 and is conveyed through the aperture 482 of the fourth plate 480 to be dispensed from the device 100 to a user. At the same time, the third plate 472 will continue to rotate with the first plate 450 so that the first chamber 452 still cannot be aligned with the aperture 472 of the third plate 470, such that the oral dosage form cannot be conveyed from the first chamber 452.

Accordingly, using the sequence of FIGS. 8D-F a second dosage may be dispensed from the device 100 corresponding to the volume of the second chamber 462.

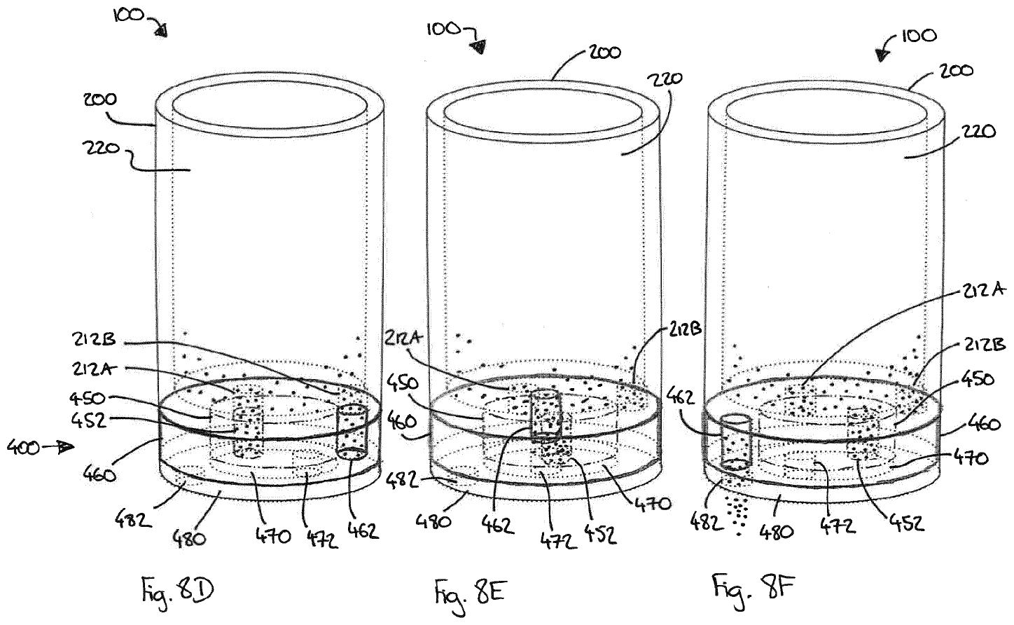

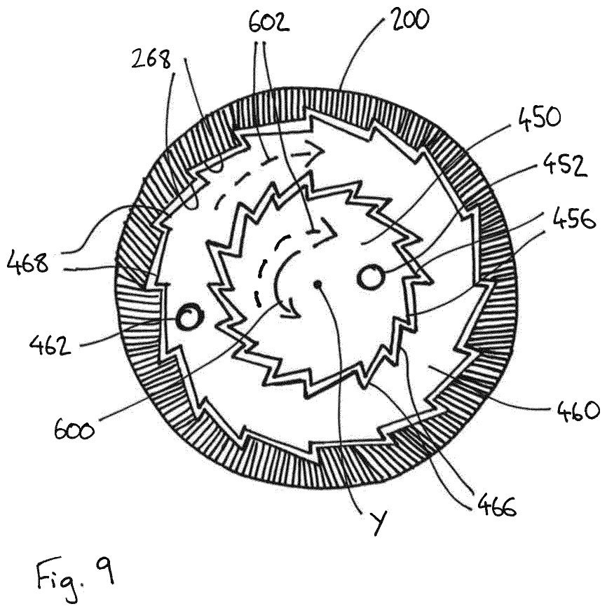

FIG. 9, which is highly schematic, shows a similar but alternative arrangement to that of FIG. 7, in which one or more ratchet mechanisms are used in place of the one-way bearing 490. In this arrangement, the first plate 450 comprises a plurality of ratchet teeth 456 around an outer (e.g., radial) periphery thereof that are configured to cooperate with a plurality of ratchet teeth 466 located on an inner periphery of the second plate 460.

The ratchet teeth 456, 466 located on the first and second plates 450, 460 may be configured to cooperate such that the first plate 450 is able to rotate in a first rotational direction (as indicated by arrow 600) without causing rotation of the second plate 460. In addition, the ratchet teeth 456, 466 located on the first and second plates 450, 460 may be further configured to cooperate such that rotation of the first plate 450 in a second, opposing rotational direction (as indicated by arrows 602) causes rotation of the second plate 460 in the same direction.

The second plate 460 may be further configured with additional ratchet teeth 468 located on its outer periphery that are configured to cooperate with ratchet teeth 268 located on an inner periphery of the cartridge 200. The additional ratchet teeth 468 and ratchet teeth 268 of the cartridge 200 may be configured to cooperate such that the second plate 460 is prevented from rotating in the first rotational direction by their engagement, whilst rotation of the second plate 460 is permitted.

The arrangement of FIG. 9 is seen as a modification of the FIG. 7 embodiment, in which the remaining features disclosed in respect of FIG. 7 remain the same. As such, the arrangement of FIG. 9 may be configured in the same manner such that an oral dosage form can be dispensed from one or other of the first and second chambers 452, 462 of the first and second plates 450, 460 as described above.

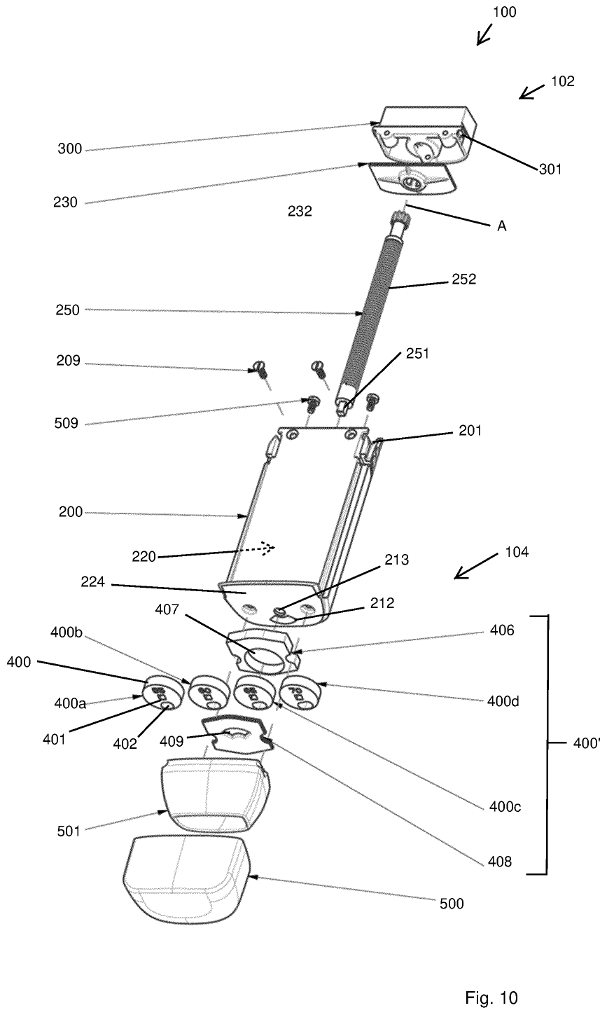

FIG. 10 shows an exploded view of a device 100 that is similar in function to those described above and incorporates some of the features.

The device 100 comprises a first end 102 at which there is located an actuator 300 (driving mechanism, e.g., a motor), and a second end 104 (opposite the first end 102) that comprises the dispensing end of the device 100. In use, the medication (e.g., oral dosage form) will be dispensed out of the second end 104 as a result of the operation of the driving mechanism. The actuator 300 can be either mechanical (e.g., manually operated) or electromechanical (e.g., electrically operated, for example an electric motor).

The device 100 comprises a cartridge 200 that is configured to attach to the actuator 300, which may be achieved using latches 201, 301, fasteners 209 or other suitable attachment mechanism.

The device 100 comprises a rotating member 250 extending through the cartridge 200. The rotating member 250 connects to the actuator 300 at the first end 102, wherein the actuator 300 is configured to rotate the rotating member 250. Each rotating member 250 may have a longitudinal axis A about which it rotates.

The cartridge 200 comprises a chamber 220 for holding a plurality of units of an oral dosage form (e.g., pellets), and through which the rotating member 250 extends. The chamber 220 comprises an outlet 212 at the second end 104, through which the oral dosage form (drug, medicament, etc.) may be dispensed from the chamber 220. The outlet 212 is shown as an arcuate aperture, which aids in the dispensing of the oral dosage form from the chamber (although any suitable shape aperture could be used).

The rotating member 250 comprises a lance 251 at and end thereof that is distal to the end that attaches to the actuator 300. The lance 251 is configured to extend through an aperture 213 of the chamber 220 and engage with a rotating member 400 as will be described in more detail below.

The device 100 further comprises a plunger 230 that is configured to move along the rotating member 250 automatically as it rotates. That is, a portion of the rotating member 250 within the chamber 220 comprises a screw thread 252, and the plunger 230 forms a nut around the rotating member 250 and is configured to travel along the screw thread 252 of the rotating member 250 as it rotates. In doing so, the plunger 230 pushes the oral dosage form towards the outlet 212 of the chamber 220.

The chamber 220 is enclosed at least in part by the plunger 230, and more specifically a radially extending surface of the plunger 230 that faces the chamber 220. The volume of the chamber 220 (i.e., prior to operation or a maximum volume) may be less than about 50 mL, for example less than 20 mL or approximately 11 mL.

Especially (although not exclusively) in the case of a liquid dosage form, the plunger 230 may be sealed (e.g., fluidly) against the walls of the chamber 220 and/or a or the screw thread 250 along which it travels, so as to prevent undesired leakage. For example, a suitable elastomeric seal could be provided that is configured to fluidly seal against the walls of the chamber 220 and/or screw thread 250.

As the plunger 230 translates along the rotating member 250 the volume of the chamber 220 gradually decreases. In use the radially extending surface 232 of the plunger 230 presses onto the oral dosage form and forces (pushes) this towards the second, dispensing end 104 of the device 100, which, in the case of a solid oral dosage form, and especially pellets, can assist in packing them tightly within the chamber 220.

FIG. 10 shows the second, dispensing end 104 of the cartridge 200, at which end there is located the outlet 212 of the chamber 220, as well as a mechanism 400′ for providing a volume based dose, a funnel 501 and a cap 500.

The mechanism 400′ for providing a volume based dose uses a rotating disc 400 (similar to the rotating member 400) described above, which comprises an aperture 401 in the center thereof and a (rotating) chamber 402 that extends through the disc 400. Four rotating discs 400a-d are shown in FIG. 10 for illustrative purposes, each configured to transfer a different volume of dose as will be described in more detail below.

The mechanism 400′ further comprises a first plate 406 that is configured to receive the disc 400, which sits inside an aperture 407 extending through the first plate 406. The aperture 407 is sized so as to receive the disc 400 and allow it to rotate within the first plate 406. The first plate 406 is secured against a lower wall 224 of the cartridge 200 (and chamber 220) through which the outlet 212 and aperture 213 extend. As such, the disc 400 within the first plate 406 is able to contact the lower wall 224 throughout its rotational movement.

The lance 251 of the rotating member 250 is configured to extend through the aperture 213 in the lower wall 224 of the cartridge 200 and fits into the aperture 401 of the disc 400. The lance 251 is configured to rotate the disc 400 as the rotating member 250 rotates. In the illustrated embodiment, the lance 251 has a cuboid shape, which matches a cuboid shape of the aperture 401 in the disc 400. Additionally, or alternatively the lance 251 could be press/interference/etc. fit into the aperture 401 so that rotation of the lance 251 causes a corresponding rotation of the disc 400.

The mechanism 400′ further comprises a second plate 408 configured to lie on top of the first plate 406 and disc 400, and enclose the disc 400 within the aperture 407 between the second plate 408 and lower wall 224 of the cartridge 200. As such, as the disc 400 rotates within the aperture 407 chamber 402 of the disc is pressed against the surface of the lower wall 224 on one side thereof, and second plate 408 on the other. It will be appreciated that for solid oral dosage forms the disc 400 does not have to be sealed against either the wall 224 or the second plate 208, and a minimal gap could be present (as long as in an intermediate position as defined herein the oral dosage form is prevented from leaving the chamber 402).

The second plate 408 comprises an aperture 409 through which an oral dosage form may be passed from the chamber 402 of the disc 400 as described in more detail below. The aperture 409 is shown as arcuate, which aids in the dispensing of the oral dosage form from the chamber 402 (although any suitable shape aperture could be used).

The chamber 402 of the disc 400 is configured to move in and out of alignment with the outlet 212 of the chamber 220 as it rotates, such that at one point during rotation of the disc 400 the chamber 402 aligns with the outlet 212. At this point an oral dosage form contained within the chamber 220 can move into the rotating chamber 402 via the outlet 212.

Similarly the chamber 402 of the disc 400 is configured to move in and out of alignment with the aperture 409 as it rotates. The chamber 402 is configured to align with the aperture 409 at a different point in its rotation than its alignment with the outlet 212. The chamber 402, outlet 212 and aperture 409 are all configured so that the oral dosage form will dispense through the outlet 212 into the chamber 402, but not at the same time through the aperture 409. This is similar to the embodiments described above.

That is, the chamber 402 is configured to selectively communicate with the outlet 212 of the chamber 220 and the aperture 409 of the second plate 408. That is, the mechanism 400′ is configured so that in a first position of the disc 400 the oral dosage form is received into the chamber 402 from the outlet 212, and in a second position thereof the oral dosage form is dispensed from the chamber 402 through the aperture 409. In other words, in the first position the chamber 402 is not in communication with the aperture 409, and in the second position the chamber 402 is not in communication with the outlet 212.

The disc 400 comprises an intermediate position between the first and second positions, in which the chamber 402 is not aligned with either the outlet 212, or the aperture 409. As such, the oral dosage form retained within the chamber 402 remains within the chamber 402, whilst the oral dosage form is not permitted to pass through from the chamber 220 of the cartridge 200 to the aperture 409.

The disc 400 may be rotated between its first position to its second position, via the intermediate position, to permit the oral dosage form to be dispensed from the device 100 in a controlled manner.

The device 100 may include a control system (e.g., as part of the actuator 300 or a control unit), which may be configured to dispense a dose of the oral dosage form contained within the chambers 220, for example after receiving an actuating signal from an input device or mechanism. The actuating signal may be initiated, for example, by a user pressing a suitable button or other input mechanism located on the control unit or optionally via a different control such as a wireless or wired, external control.

By using an electromechanical actuating mechanism, the device 100 may be able to dispense a precise dose or amount (e.g., volume) of the oral dosage form repeatedly. The motors 302, and the control system may be powered by an integrated battery (which may be user replaceable), which may be held within the housing of the actuator 300.

The actuator 300 may comprise one or more motors 302. The actuator 300 (e.g., the motors 302 thereof) may be configured to rotate each rotating member 250 by an amount corresponding to a prescribed dose, or a portion of a dose (which may correspond to a specific volume of the oral dosage form).

The motors 302 may be stepper motors, which could be configured to rotate a respective rotating member 250 by any suitable number of steps based on the situation at hand, e.g., based on the type of medicament within the cartridge 200, or the user. The control system may be provided in the form of a computer, processor, processing device, circuitry or microcontroller, e.g., on a PCB, which may be located within the housing of the device 100 of within the actuator 300 or control unit.

The actuator 300, if provided with an electromechanical motor 302, may be configured to rotate a respective rotating member 250 at a rate of between about 50 rpm and about 500 rpm, optionally between about 90 rpm and about 150 rpm.

However the actuator 300 is provided, the dose to be dispensed from the device 100 corresponds to the volume of the chamber 402 of the disc 400. In order to dispense different volumes of dose, different discs 400 could be used, as shown in FIG. 10 with discs 400a-d. Each of the discs 400a-d comprises a different sized chamber 402 so that each disc is configured to dispense a different volume of dose with one rotation thereof. It is also possible that different volumes of dose could be dispensed by rotating the disc 400 multiple times. The actuator 300 could be configured to control the volume of the dose by controlling the number of rotations of the disc 400 in this manner.

The device 100 further comprises a funnel 501 that is configured to fit over the surface 224 of the cartridge 200. The funnel 501 may be secured to the cartridge 200 using any suitable device, for example fasteners 509 (or clips, or even molded onto the chamber 220). The mechanism 400′ for providing a volume-based dose may be contained within the funnel 501, which could be configured to fix the various parts of the mechanism 400′ in position. For example, the funnel 501 could be configured to press the second plate 408 against the first plate 406 and, in turn, causes the first plate 406 to be pressed against the lower wall 224 of the cartridge 200. In this manner the aperture 407 within which the disc 400 sits could be configured as a substantially closed/sealed cavity, with an entrance formed by the outlet 212 of the chamber 220 and an exit formed by the aperture 409 of the second plate 408.

The device 100 further comprises a cap 500, which may comprise a collection region in the form of a cavity within the cap 500. The cap 500 may be configured to fit over the funnel 501 and onto the cartridge 200 so that the oral dosage form dispensed into the collection region is held in the cavity within the cap 500. In order to access the oral dosage form, the cap 500 is configured to be removable from the remainder of the device 100 (e.g., via a snap fit), so that a user can expose the collection region and access the oral dosage form.

The methods, method steps, or functional features disclosed herein, for example in connection with the control system of the control unit described above, may be implemented at least partially using software, e.g., computer programs. These may be located on a processor or circuitry forming part of the control unit itself. It will thus be seen that when viewed from further aspects the present invention provides computer software specifically adapted to carry out the methods, method steps, or functional features herein described when installed on data processing means, a computer program element comprising computer software code portions for performing the methods, method steps, or functional features herein described when the program element is run on data processing means, and a computer program comprising code means adapted to perform all the steps of a methods, method steps, or functional features herein described when the program is run on a data processing system. The data processor may be a microprocessor system, a programmable FPGA (field programmable gate array), etc.

Although the present invention has been described with reference to preferred embodiments, it will be understood by those skilled in the art that various changes in form and detail may be made without departing from the scope of the invention as set forth in the accompanying claims.

What is claimed is:

1. A device for dispensing an oral dosage form, comprising:
a cartridge comprising one or more chambers for containing an oral dosage form, wherein each of the one or more chambers comprises at least one outlet for dispensing the oral dosage form from the chamber;
a member that is movable between first and second positions, wherein in the first position the member is configured to receive and hold a specific volume of the oral dosage form from one of the chambers of the cartridge via one of the outlets, wherein the member is movable to one or more intermediate positions in which the specific volume of the oral dosage form is held and retained within the movable member such that the oral dosage form cannot be dispensed therefrom, and the member is movable from the intermediate position(s) to a second position in which the oral dosage form held within the movable member can be dispensed therefrom.

2. The device as claimed in claim 1, wherein the oral dosage form is solid and a largest dimension (e.g., width or diameter) of the solid oral dosage form is between about 100 μm and about 1200 μm.

3. The device as claimed in claim 1, wherein the oral dosage form is provided as solid units and a largest dimension (e.g., width or diameter) of the units is between about 100 μm and about 300 μm.

4. The device as claimed in claim 3, wherein the units of the solid oral dosage are made of a compressible and/or porous material.

5. The device as claimed in claim 1, wherein the movable member is a rotatable disc comprising at least one chamber for holding and retaining a specific volume of the oral dosage form as aforesaid.

6. The device as claimed in claim 1, wherein the movable member comprises at least one chamber for holding and retaining a specific volume of the oral dosage form as aforesaid.

7. The device as claimed in claim 5, wherein in the intermediate position the at least one chamber of the movable member is sealed and isolated from the one or more chambers of the cartridge.

8. The device as claimed in claim 5, wherein each chamber of the member is configured to receive and hold a separate volume of the oral dosage form from the cartridge.

9. The device as claimed in claim 5, wherein the at least one chamber of the member comprises a first chamber configured to receive and hold a first volume of the oral dosage form from the cartridge, and a second, separate chamber configured to receive and hold a second volume of the oral dosage form from the cartridge.

10. The device as claimed in claim 9, wherein the first volume of oral dosage form is different to the second volume of oral dosage form.

11. The device as claimed in claim 9, wherein the cartridge comprises a first chamber and a second, separate chamber, wherein each of the first and second chambers of the cartridge are configured such that the oral dosage form in one chamber does not intermix with the oral dosage form in the other chamber, wherein each chamber of the cartridge comprises a separate outlet for dispensing the oral dosage form from the respective chamber.

12. The device as claimed in claim 11, wherein the first chamber of the movable member is configured in the first position thereof to receive and hold the first volume of oral dosage form from one of the first and second chambers of the cartridge via its respective outlet, and the second chamber of the movable member is configured in the first position thereof to receive and hold the second volume of oral dosage form from the other of the first and second chambers of the cartridge via its respective outlet.

13. The device as claimed in claim 9, wherein in the first position of the member the first and second chambers thereof are both configured to receive and hold a separate volume of oral dosage form from the cartridge at the same time, wherein in the second position of the member the first and second chambers thereof are both configured to dispense their respective volumes of oral dosage form therefrom.

14. The device as claimed in claim 9, wherein in the first position of the member the first chamber thereof is configured to receive and hold a volume of oral dosage form from the cartridge, whilst the second chamber of the member is prevented from receiving the oral dosage form from the cartridge, and in the second position of the member the first chamber thereof is configured to dispense its volume of oral dosage form and the second chamber of the member is configured to receive and hold a volume of oral dosage form from the cartridge.

15. The device as claimed in claim 9, wherein the movable member comprises a first portion having the first chamber thereof and a second, separate portion having the second chamber thereof, wherein the first and second portions are movable relative to each other.

16. The device as claimed in claim 15, wherein the first and second portions are movable relative to each other such that in a first relative position of the first and second portions the first and second chambers of the member align such that the oral dosage form can pass therebetween, and in a second relative position of the first and second portions the first and second chambers of the member move out of alignment such that the oral dosage form cannot pass therebetween.

17. The device as claimed in claim 16, wherein in the first position of the movable member the first and second portions thereof are movable into alignment to their first relative position, such that they are both configured to receive and hold a volume of oral dosage form from the cartridge at the same time, wherein the first and second portions of the member are configured to remain aligned in their first relative position throughout movement of the member to its second position, such that a volume of oral dosage form corresponding to the combined volume of the first and second chambers of the member can be dispensed therefrom.

18. The device as claimed in claim 16, wherein in the first position of the movable member the first and second portions thereof are movable out of alignment to their second relative position, such that only one of the first and second chambers is configured to receive and hold a volume of oral dosage form from the cartridge, wherein the first and second portions of the member are configured to move from their second relative position to their first relative position throughout movement of the member to its second position, so as to become aligned such that a volume of oral dosage form corresponding to the one of the first and second chambers of the member can be dispensed therefrom.

19. The device as claimed in claim 15, wherein the first portion comprises a first disc having the first chamber of the member, and the second portion comprises a second disc having the second chamber of the member, wherein the first and second discs are rotatable relative to each other and the cartridge.

20. The device as claimed in claim 19, wherein the first disc is rotatable between a first position in which the first chamber thereof is configured to receive and hold a specific volume of oral dosage form from the cartridge, wherein the first disc is rotatable to one or more intermediate positions in which the oral dosage form held within the first chamber thereof as a specific volume is substantially fixed, and the first disc is rotatable from the intermediate position(s) to a second position in which the oral dosage form held within the first chamber thereof can be dispensed therefrom.

21. The device as claimed in claim 19, wherein the second disc is rotatable between a first position in which the second chamber thereof is configured to receive and hold a specific volume of oral dosage form from the cartridge, wherein the second disc is rotatable to one or more intermediate positions in which the oral dosage form held within the second chamber thereof as a specific volume is substantially fixed, and the second disc is rotatable from the intermediate position(s) to a second position in which the oral dosage form held within the second chamber thereof can be dispensed therefrom.

22. The device as claimed in claim 19, wherein the member is configured such that upon rotation of the first disc in a first direction the second disc is also configured to rotate, whilst upon rotation of the first disc in a second, opposite direction the second disc is configured to remain stationary.

23. The device as claimed in claim 22, wherein a one-way bearing is located between the first and second discs.

24. The device as claimed in claim 22, wherein a ratchet mechanism is located between the first and second discs.

25. The device as claimed in claim 1, wherein the device comprises one or more outlet passages configured to receive the oral dosage form dispensed from the movable member in the second position thereof.

26. The device as claimed in claim 5, further comprising:
a rotating member extending through the cartridge and configured to rotate the disc.

27. The device as claimed in claim 26, further comprising an actuator configured to rotate the rotating member.

28. The device as claimed in claim 27, further comprising a plunger configured to move along the rotating member automatically as it rotates, and push the oral dosage form towards the outlet of the chamber in use.

29. The device as claimed in claim 1, wherein the device is a hand-held device.

30. The device as claimed in claim 1, further comprising a plurality of compressible and/or porous pellets providing the oral dosage form contained within each of the one or more chambers.
